(19) United States
(12) Patent Application Publication
(10) Pub. No.: US 2023/0020336 A1
(43) Pub. Date: Jan. 19, 2023

(54) SYSTEM AND METHOD FOR IMPLEMENTING INTEGRATED FINANCIAL SERVICES FUNCTIONALITY IN A CASINO ENVIRONMENT

(71) Applicant: Everi Payments Inc., Austin, TX (US)

(72) Inventor: Victor Newsom, Las Vegas, NV (US)

(21) Appl. No.: 17/947,433

(22) Filed: Sep. 19, 2022

Related U.S. Application Data
(63) Continuation of application No. 17/492,596, filed on Oct. 2, 2021.
(60) Provisional application No. 63/112,402, filed on Nov. 11, 2020.

(51) Int. Cl. G06Q 20/10; G06Q 40/02; G06Q 50/34; G06Q 20/18; G06Q 20/36; G06Q 20/06; G06Q 20/40

(52) U.S. Cl. CPC G06Q 20/108; G06Q 40/02; G06Q 50/34; G06Q 20/18; G06Q 20/36; G06Q 20/065; G06Q 20/4015

(57) ABSTRACT

A system for implementing integrated financial services functionality in a casino environment may comprise a channel that integrates with casino devices and systems. The financial services system may comprise or implement an exchange relative to the casino environment and one or more external banking networks. Each patron may have a personal exchange which represents funds associated with account at an external bank. The system permits a patron to associate funds with their exchange and to utilize funds associated with their exchange at touch-points throughout a casino (including both gaming and retail locations), such as for funding wagering activities or paying for goods and/or services on the retail side. The financial services system may be accessed by a patron in various manners, including by an application running on the patron's computing or mobile device, via kiosks or other service devices, via a casino cage or cashier, or via other touch-points.

### RELATED APPLICATION DATA

This application is a continuation-in-part of U.S. application Ser. No. 17/492,596, filed Oct. 2, 2021, which claims priority U.S. Provisional Application Ser. No. 63/112,402, filed Nov. 11, 2020, and incorporates by reference said prior applications as if set forth fully herein.

### FIELD OF THE INVENTION

The present invention relates to methods and systems for facilitating financial transactions, particularly in a casino environment.

### BACKGROUND OF THE INVENTION

Casino gaming has evolved tremendously over the last several decades. In the early days, players who visited casinos had to take cash with them to wager or had to obtain a casino marker—a form of ‘on property’ credit, to fund their wagering. The casinos would collect the monies wagered by players, such as collected at cash boxes at gaming tables and in coin boxes at slot machines, and take those monies to a back room for counting and book keeping.

Over time, various solutions have been developed to facilitate, including by automating, some aspects of casino operations and/or to provide improved customer service at casinos. For example, as casino gaming machines moved from mechanical devices to electro-mechanical or full electronic device, those devices were connected to back end casino account systems, allowing casinos to track amounts wagered and paid at each gaming machine, thus improving casino accounting. As another example, player tracking systems were developed which allow casinos to track the game play of individual players, such as by issuing a player card to the player that the player uses to identify themselves at a gaming machine. These systems allow casinos to obtain information about players and their game play, such as for determining complimentary awards or promotions to be awarded to players which are based upon actual metrics associated with each individual player's activities.

Similar advancements have been made in other areas, including relative to back-end casino regulatory compliance. For example, casinos have to report certain financial transactions to regulatory agencies. Systems have been developed to aid casinos in such reporting, including gathering and logging financial transactions occurring at the casino for reporting.

On the player side, to reduce the need for players to bring their own cash to a casino, casinos allow ATMs to be placed on and around the gaming floor. This allows players to use their bank card to obtain cash directly at the casino.

Still, a number of problems still exist. For example, the various casino systems are often provided by different vendors and are thus not integrated, which causes a number of problems. One problem is that the disparate casino systems often do not individually, or even collectively, address all of the needs of the casino. Another problem is that the casino may need to examine the operation and output of multiple individual systems in order to obtain information regarding certain events or activities, which can be time consuming, if not futile. As one example, a casino may operate a cashier system for facilitating and tracking financial transactions at the casino cage/cashier. While a casino's electronic gaming machines may be linked via a machine accounting system, the casino's cage system and the casino's gaming machine systems may not integrate, still requiring the casino to aggregate information from between those different systems.

Further, casinos are still seeking new ways to improve customer service. This is made difficult by the ever expanding offerings of casinos as well as the fact casinos are highly regulated. For example, casinos may include hotel services, retail, food and beverage and gaming services. A casino operator desires to make it as easy as possible for a player to pay for retail goods, food and beverage and fund gaming activities. However, the casino operator might operate the gaming floor, but might lease space to a vendor that operates a restaurant, making it more difficult for the casino to facilitate a player's transactions at the restaurant. Further, unlike retail stores where a customer may simply make individual retail purchases, a casino may need to provide a player with access to cash or credit, and needs to track the flow of those funds, such as for reporting. These and other problems are impediments to addressing customer service issues.

As one example, IGT of Las Vegas, Nevada has announced the introduction of a product it calls “Resort Wallet.” As described in U.S. Pat. No. 10,810,835 to IGT, the Resort Wallet is essentially a collection of accounts. In particular, as described therein, a “collection of cashless wagering accounts (i.e., cashless wagering wallets) and gaming establishment retail accounts (i.e., gaming establishment retail wallets) associated with or otherwise maintained for a player or user collectively form a resort or enterprise account (i.e., an integrated resort wallet) which the player or user may access to transfer funds and/or view balance information amongst the various accounts associated with or otherwise maintained for the player or user.”

While the resort wallet allows a player to have different accounts for paying for retail purchases and for funding wagering, the resort wallet as simply comprising a collection of casino monetary value accounts has a number of drawbacks.

For example, as described in the '835 patent, “the gaming establishment retail account is a retail account with a balance or a pre-paid access account which, per current regulations from the U.S. Treasury Department Financial Crimes Enforcement network N (“FinCEN”), cannot be convertible to cash and can only be used for the purchase of goods and/or services. Such a gaming establishment retail account (i.e., a gaming establishment retail wallet) of a gaming establishment retail system integrates with various retail point-of-sale systems throughout the gaming establishment to enable players/users to purchase goods and/or services via the player's gaming establishment retail account.” The '835 patent thus further notes that, as a result “while an amount of funds deposited in a gaming establishment retail account may be used with various retail point-of-sale systems throughout the gaming establishment to enable players/users to purchase goods and/or services (and, as described herein, be used to fund a cashless wagering account with an amount of non-cashable credits), such funds deposited in the gaming establishment retail account cannot be converted to cash.”

The above-described limitation is obviously a very significant limitation upon the ability of the player to use, transfer and manage their funds. For example, if a player obtains funds from their bank account, such as by cashing a check or obtaining the funds via an ATM, and then deposits those funds to such a retail wallet account, the player can't then remove those funds from the account as cash—such as if the player does not spend all of the funds on retail purchases. Further, while the described resort wallet offers the ability of a player to associate funds with accounts from which the funds may be accessed, those funds are not protected funds (such as funds in a bank account that is FDIC insured). The manner by which the player may fund the accounts and/or remove funds from the account may also be severely limited—at least when viewed by the player in comparison to the various mechanisms for depositing, accessing and transferring funds to and from their own bank account.

### SUMMARY OF THE INVENTION

Aspects of the invention comprise methods and systems for providing integrated financial services functionality in a casino environment.

In one embodiment, the system for implementing integrated financial services functionality in a casino environment may comprise a channel that integrates with casino devices and systems. The financial services system may comprise or implement an exchange relative to the casino environment and one or more external banking networks. Each player or patron may have a personal exchange which represents funds associated with account at an external bank. The system permits a patron to associated funds with their exchange and to utilize funds associated with their exchange at touch-points throughout a casino (including both gaming and retail locations), such as for funding wagering activities or paying for goods and/or services on the retail side. The financial services system may be accessed by a patron in various manners, including by an application running on the patron's computing or mobile device, via kiosks or other service devices, via a casino cage or cashier, or via other touch-points.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a system in accordance with the present invention;

FIGS. 2A-2L are flow diagrams which illustrate aspects of processing of financial transactions in accordance with the invention;

FIGS. 3A-C, 4, 5, and 6A-C illustrate aspects of an user application, including functionality implemented by one or more graphical user interfaces of the application;

FIGS. 7A-E, 8A-E, 9A-C and 10A-B illustrate aspects of processing a funds transaction at a kiosk using an application;

FIGS. 11A-G illustrate aspects of generating and associating a retail credit card account with a patron exchange;

FIG. 12 illustrates aspects of the system of the invention as interfacing to one or more gaming machines;

FIG. 13 illustrates aspects of the system of the invention as used to associate cryptocurrency with a patron's exchange; and

FIG. 14 schematically illustrates additional aspects of a system of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Aspects of the invention comprise methods and systems for implementing integrated financial services functionality in a casino environment. In some examples, the invention comprises a financial services system, such as configured as a “channel”, that integrates with casino devices and systems (such as, but not limited to casino loyalty systems, jackpot payment devices/systems, cage/cashier devices and systems, kiosks, slot or machine management systems, back-end financial reporting and accounting systems, etc.; such systems may comprise, for example, the JackpotXchange®, JackpotXPress®, PitXpress™, Concierge™ and other products/systems of Everi Payments, Inc., of Las Vegas, Nev.). In some examples, the financial services system is configured as an electronic financial exchange relative to the casino environment and an external banking network, such as relative to a patron's funds associated with a funds account at a financial institution (which may be referred to as an exchange account or exchange bank account). The financial services system allows a patron to freely move funds associated with their exchange (and the exchange bank account holding the funds associated with their exchange) to and from one or more other accounts, such as personal checking and savings bank accounts. As the same time, a patron may utilize funds associated with their exchange at touch-points or end-points throughout a casino (including both gaming and retail locations), such as for funding wagering activities or paying for goods and/or services on the retail side. The financial services system or exchange may be accessed by a patron in various manners, including by an exchange application running on the patron's computing or mobile device, via kiosks or other service devices, via a casino cage or cashier, or via other touch-points.

Integrated Casino Financial Services System

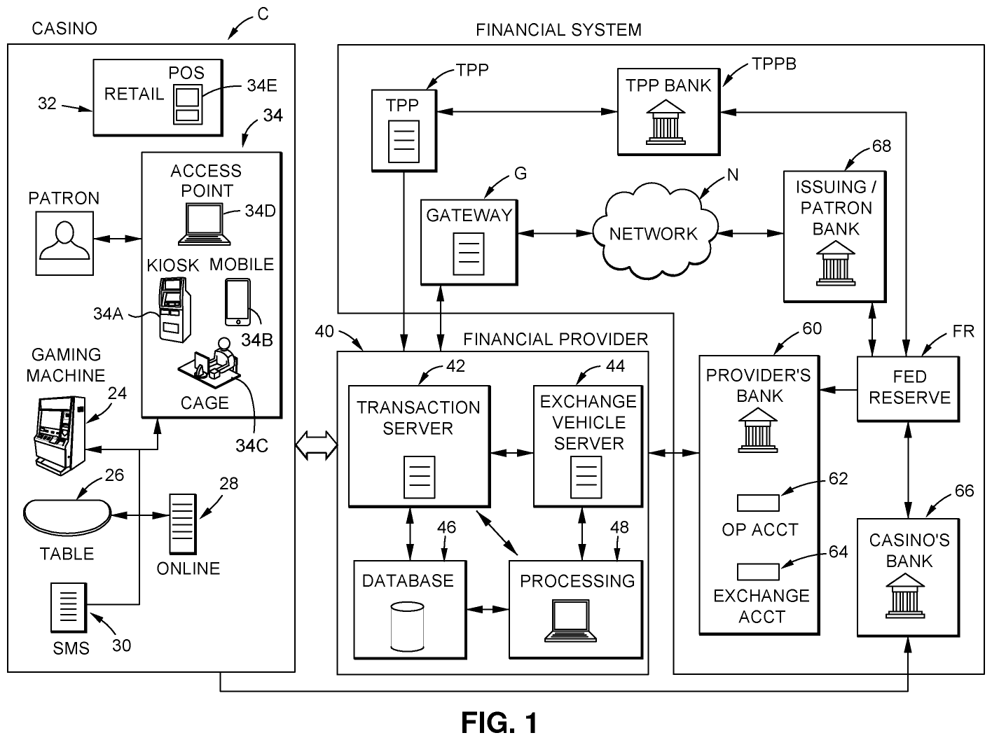

Aspects of the invention will be described first with reference to FIG. 1. As illustrated, an environment of the invention comprises a combination of devices and systems, wherein the devices and systems (or elements thereof) may be at the same or different locations. In one embodiment, the devices and systems effectively implement a casino financial services system 20. The casino financial services system 20 may be implemented by dedicated devices, or may effectively comprise a “channel”, such as a digital channel, that is implemented via one or more existing devices (such as modified to implement the functionality described herein), or combinations thereof. As detailed below, in that the system 20 facilitates transactions via a plurality of different pathways, including to different sources and end-points, the system 20 may be referred to as a multi-channel or omni-channel system. Further, in that the casino financial services system 20 is configured to facilitate financial transactions between a banking system and a casino C, the system 20 may be referred to generally as an exchange.

In a preferred embodiment, the casino financial services system 20 is for use with and/or in a casino or casino environment C. The casino C may comprise an environment where gaming, such as wager-based gaming, is offered, such as at one or more gaming machines 24, gaming tables 26 or other locations (such as in a sports book, bingo parlor, etc.). The casino C may also offer gaming online, such as via one or more servers 28.

The casino C may have various systems. In one embodiment, a slot management system 30 may be used to track and/or facilitate activities within the casino C, such as at the gaming machines 24, gaming tables 26 and the like. The slot management system 30 may, for example, enable a patron tracking system which tracks the play of patrons in the casino C, such as amounts wagered, won, lost, etc. by each patron. In one embodiment, the slot management system 30 may also provide accounting functionality, such as tracking amounts wagered, paid and lost at each gaming machines 24, table 30 or the like. Of course, these various functions (such as accounting, player tracking etc.) may be separated into different systems.

In one embodiment, the casino C may also offer various retail (e.g., non-gaming) features 32, such as stores, restaurants and the like, where patrons may make purchases of goods and/or services (which may be operated by the casino C, be operated by third parties, etc.).

As described in more detail below, in one embodiment, patrons (as used herein, patrons may comprise or be referred to as players, customers, etc.) may interact with one or more access or “touch” points. These access points 34 may comprise, for example, one or more kiosks 34A, mobile devices 34B (including a mobile device of the patron, such as a phone, PDA, tablet, etc.), a casino cage 34C, or various other terminals 34D or the like). Further, the touch or access points might comprise a point of sale (POS) device 34E or other device, such as associated with or located at a retail location 32. As described below, these access points 34 may be used by a patron to enroll in or create a personal exchange for the patron, wherein the patron's exchange is associated with an exchange account 64 comprising an account at a bank or other financial institution, to associate funds with their exchange, to withdraw funds therefrom, and/or engage in other transactions.

In one embodiment, various financial transactions may be enabled via a financial provider, such as via a financial provider system 40, including relative to a financial network or system FS. In one embodiment, the financial provider system 40 may include one or more financial servers 42, an exchange server 44, a transaction and information database 46, and a processing server or system 48. In general, the financial server 42 may be configured to facilitate various requested financial transactions, such as requested by a patron from one of the access points 34. The database 46 may be configured to store information, and particularly financial transaction and/or patron information. The exchange server 44 is preferably configured to implement exchange functionality described herein, such as by creating and managing an exchange for a patron and tracking funds of the patron which are associated with an exchange account 64 which is linked to the patron's exchange). The processing system 48 may be used to generate settlement files, perform accounting/reconciliation, etc., as described in more detail below.

In one embodiment, features of the financial provider system 40 may be located remote from the casino C, while other features might be located at the casino C. The financial provider system 40, or elements thereof, might be operated by a financial provider vendor to the casino C, but might be operated by the casino C. In one embodiment, information may be exchanged between various devices at the casino C and the financial provider system 40. For example, requests for financial transactions may be placed at access points 34 and provided to the financial provider system 40. Responses to such requests may be provided from the financial provider system 40 to the access points 34 and/or to the casino C.

The financial system FS may comprise various elements of existing financial institutions and networks, plus additional features or elements. For example, the financial system FS may comprise one or more banks or other financial institutions. For example, the financial system FS may include a provider bank 60—e.g. a bank that the financial provider utilizes, such as to support an operating bank account 62 and one or more exchange accounts 64. The financial system FS may also comprise a casino bank 66—e.g. a bank that the casino C utilizes, and one or more issuing or patron banks 68—e.g. a bank where a patron maintains a bank account of funds or which is the issuer of a bank card (credit card, etc.) used by the patron.

The financial system FS may include various other elements, such as: 1) one or more third party processors TTP, such as for facilitating the processing of various financial transactions; 2) one or more gateways G which facilitate the exchange of information between the financial provider 40 and the financial system FS; 3) one or more networks N, which may comprise secured and/or unsecured communication links; 4) other banks or financial institutions, such as third party processor banks TPPB; 5) the Federal Reserve bank/system FR, and/or other systems and devices.

The various banks or other financial systems may themselves have various systems and devices, such as bank servers, work stations, databases, etc.

The casino financial services system 20 may support and/or enable various financial-related functionality. One feature is an exchange or exchange functionality. This functionality may comprise the creation or establishment of a patron exchange (such as via an onboarding/enrollment process) and the ability to move funds using the exchange, including from a source of funds to their exchange or to move funds from their exchange to another location—such as to fund gaming at the casino, pay for retail purchases and the like.

Aspects of this functionality will be described in more detail with reference to FIG. 1. In one embodiment, the financial provider creates an exchange for each patron, such as upon a request from the patron, such as via the exchange server 44. Funds that a patron associates with their exchange are associated with an exchange account 64, which preferably comprises an account at the financial provider's bank 60. In this configuration, it will be appreciated that the patron's exchange may simply comprise a file or ledger having associated information, wherein one aspect of the exchange comprises information regarding a balance of funds that are associated with the patron and maintained in the exchange account 64 (preferably at an account at the financial provider's bank 60). As disclosed below, the patron's exchange may be maintained in a ledger or similar format by the exchange server 44. As indicated, any funds which are associated with the patron's exchange are associated with a financial account at a financial institution, such as the exchange account 64 at the financial provider's bank, as described above. In one embodiment, each patron has a different exchange (such as represented by information associated with a file or ledger maintained by the exchange server 44; e.g. Patron 1: current balance $450.00; Patron 2: current balance $1,000.00), but the funds of multiple patrons are associated with a single exchange bank account 64 (such as at the provider's bank), such that each patron's exchange essentially reflects a funds balance which is a portion of that single bank account. However, in other embodiments, the funds associated with each patron's exchange may be associated with a separate exchange bank account.

In general, in this configuration, when a patron seeks to perform a financial transaction relative to their exchange (such as by moving funds to or from their exchange), the request is provided (such as from one of the touch or access points 34) to the financial provider FP. The financial provider FP performs initial processing of the request, as necessary. For example, relative to a request by a patron to remove funds from their exchange, the financial provider FP may first determine if the requested amount of funds exists in their exchange (such as by checking the current funds balance of the patron's exchange at the exchange server 44, which represents a balance of funds of the patron in the exchange account 64 at the financial institution), and then communicates with the financial system FS in order to effectuate the transaction. This may comprise, for example, communicating with a patron's bank in order to remove funds from a patron's bank account and transfer the funds from the patron's bank account to the patron's exchange (such as effected via deposit of the funds with the exchange account 64 at the financial provider's bank 60).

Exemplary Financial Transactions

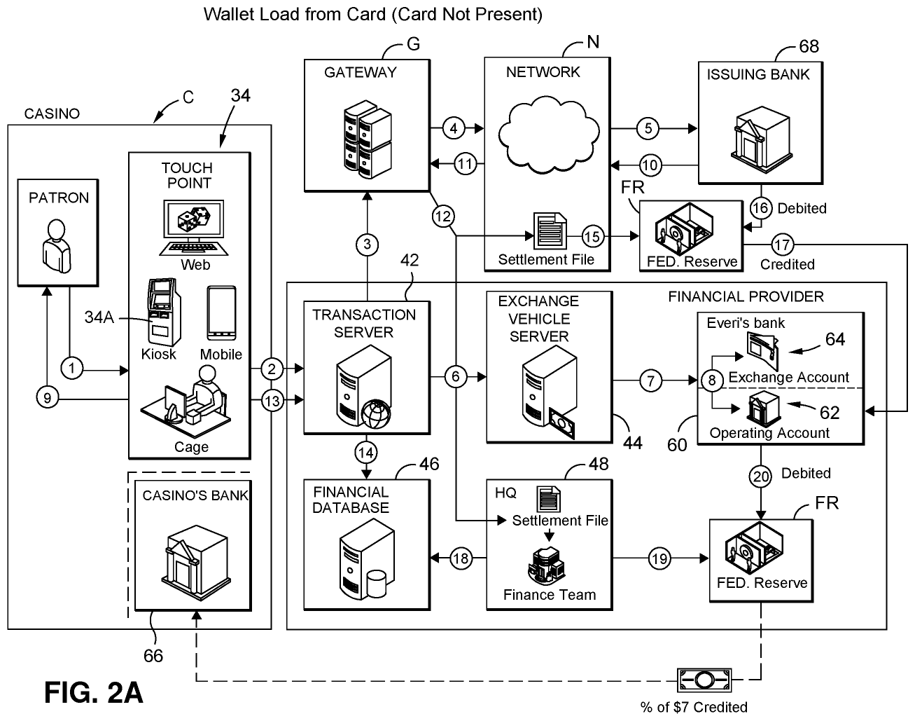

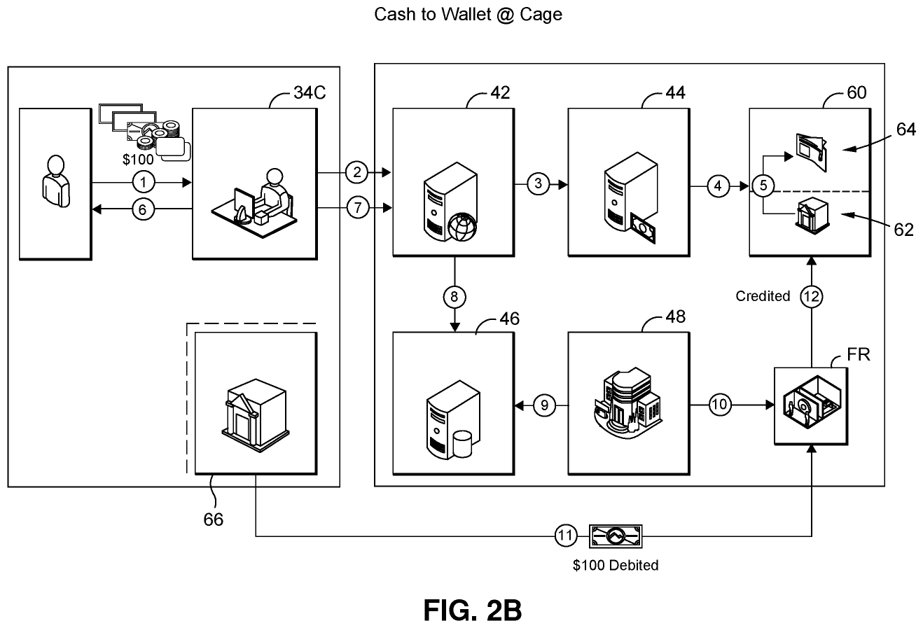

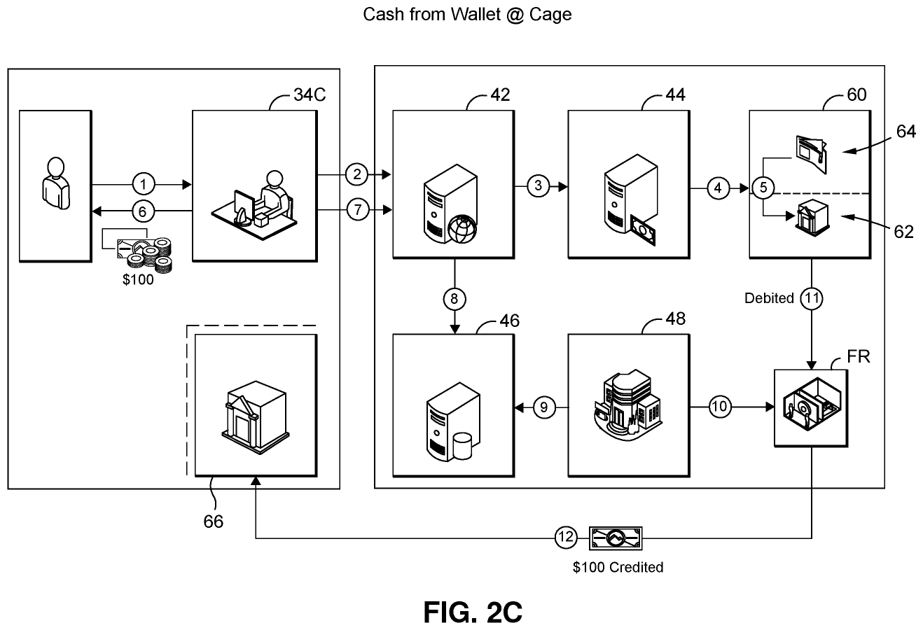

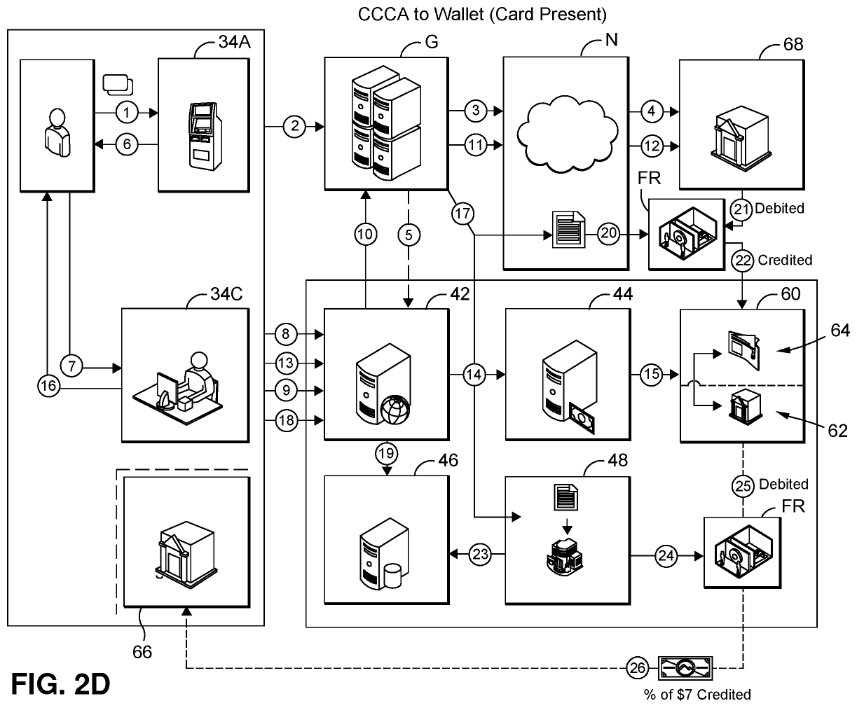

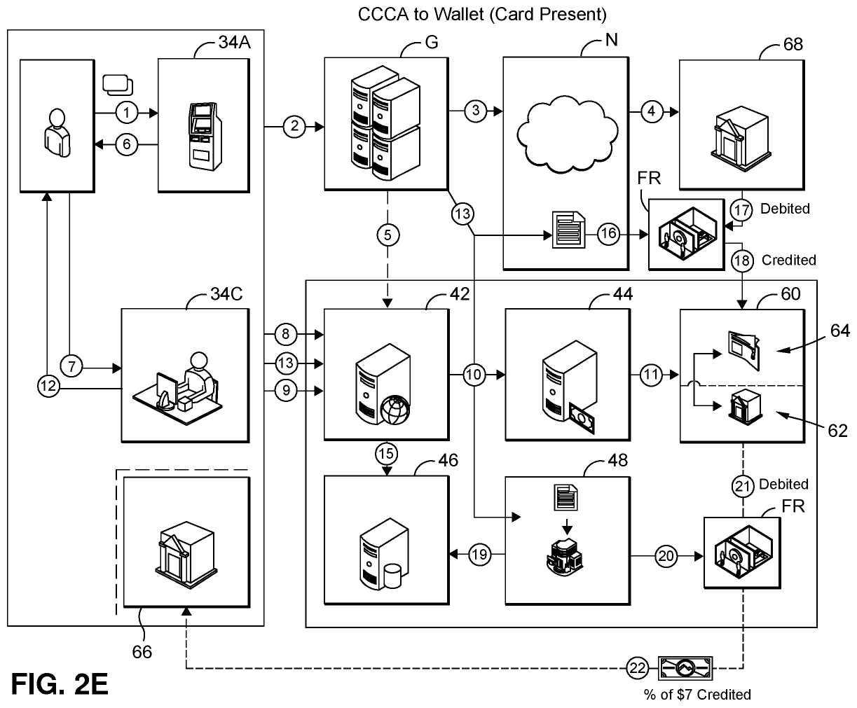

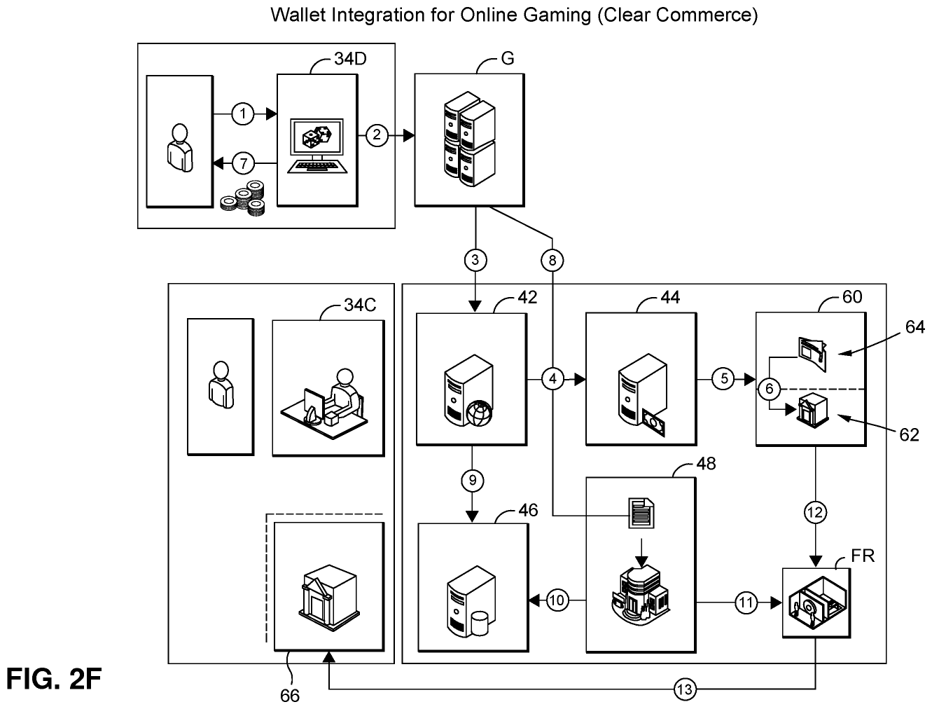

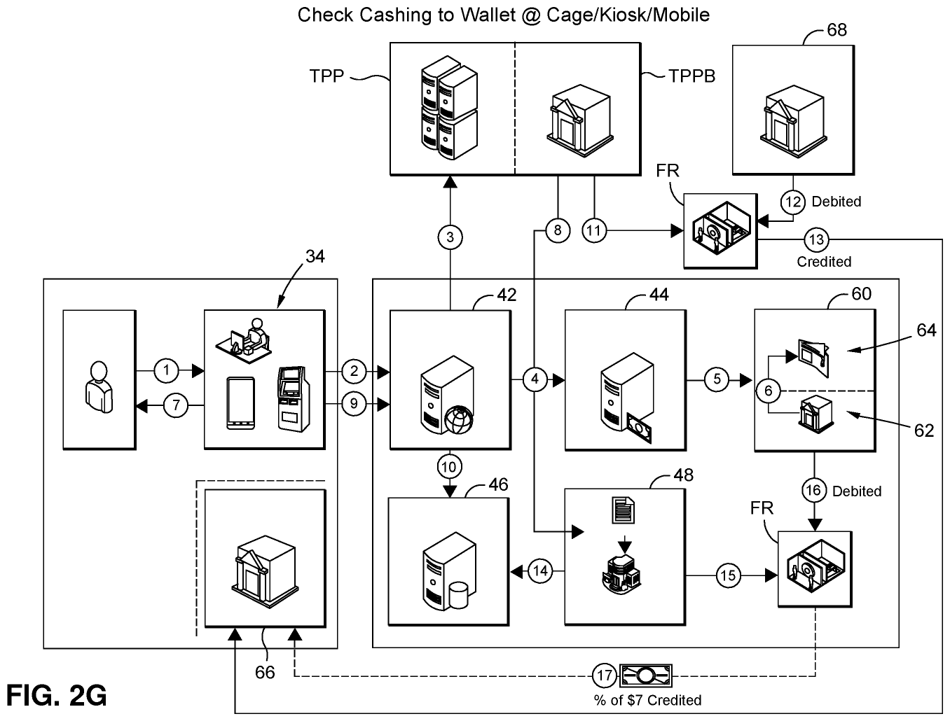

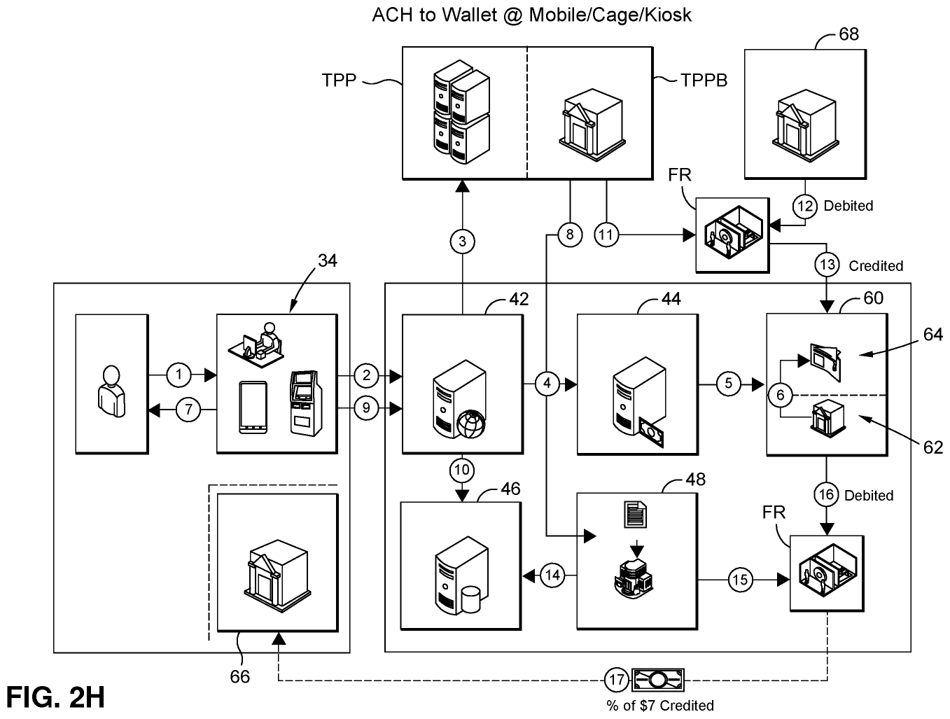

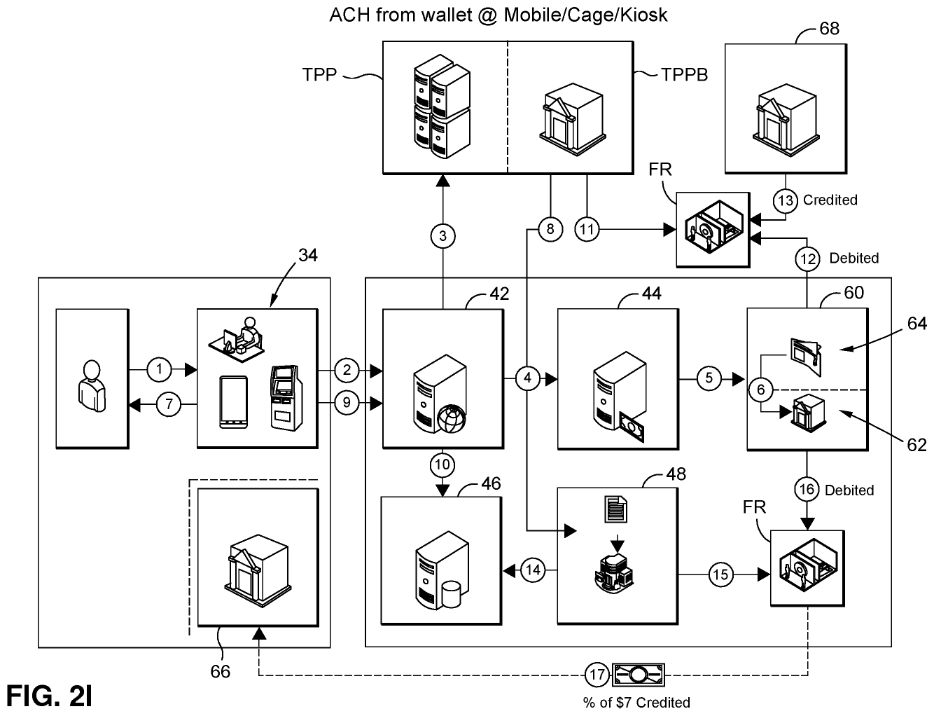

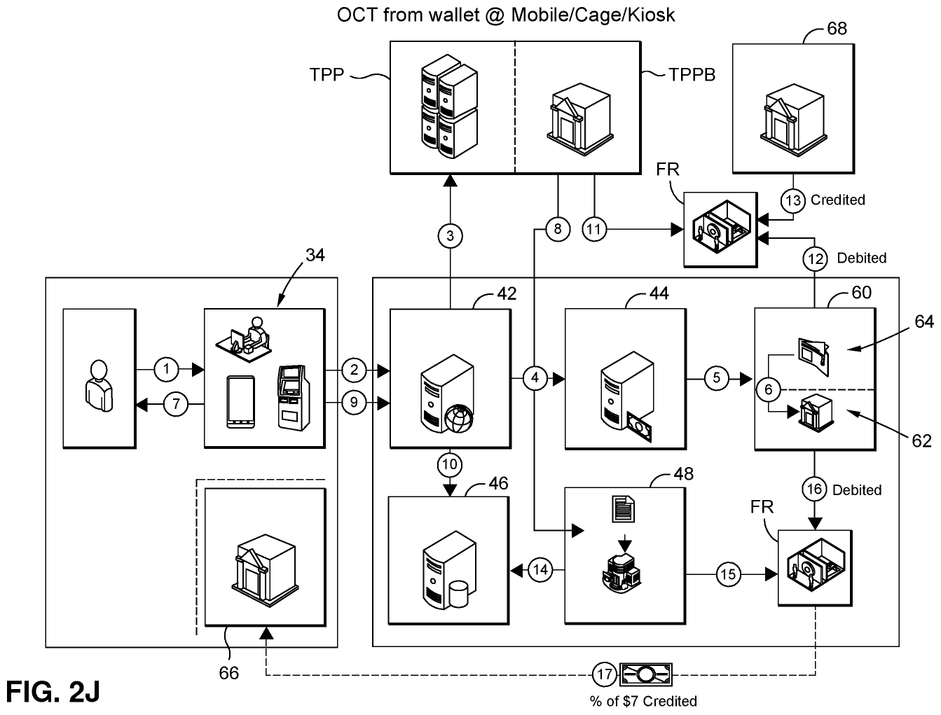

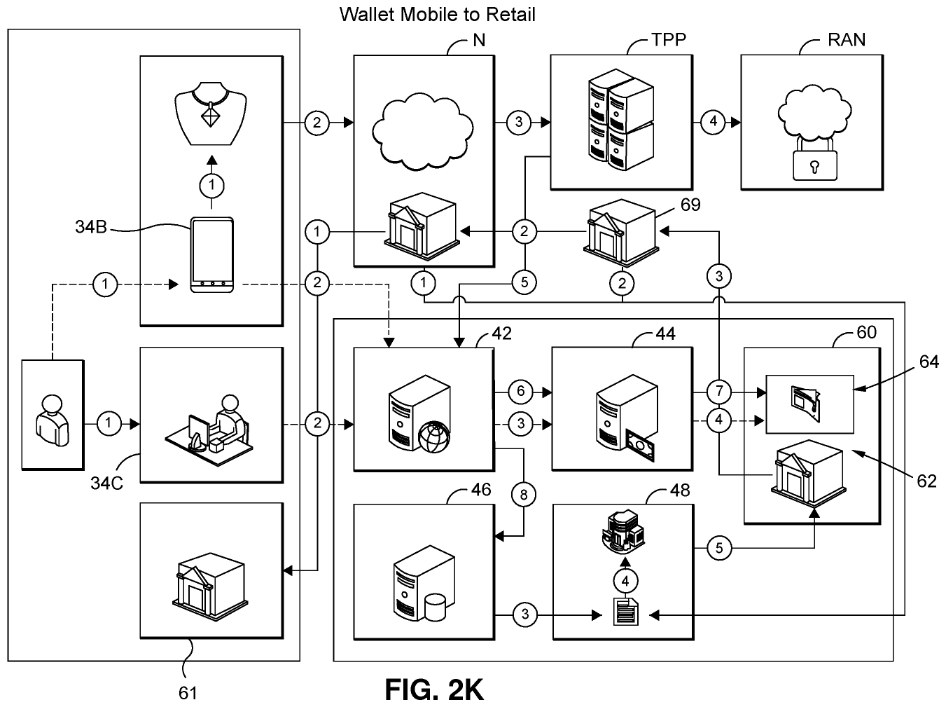

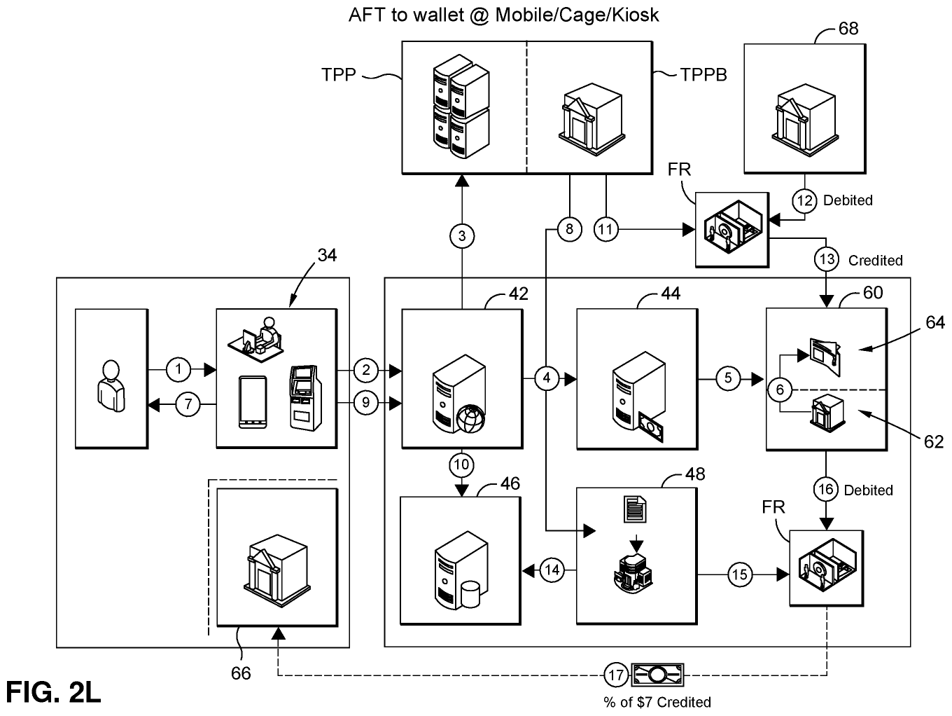

FIGS. 2A-2L are flow diagrams which illustrate various aspects of facilitating financial transactions, such as relative to a casino using a patron's exchange in accordance with the invention, including aspects of moving funds to and from various casino devices and systems, external accounts and the like.

FIG. 2A is a flow diagram which illustrates a process by which a patron may associate funds with their exchange as sourced from a bank card. This request may be implemented by the patron by one of the access or touchpoints 34. Table 2A sets forth details of transaction flow, settlement of funds flow, and fee settlement flow, for such a transaction.

```
TABLE 2A
Transaction Flow:
  1. Patron requests funds (e.g. $100 w/ $7 fee) from a touchpoint 34
  2. Touchpoint 34 sends request to transaction server 42
  3. Transaction server 42 sends request to gateway G
  4. Gateway G sends request to network N
  5. Network N sends request to issuing bank 68, response sent back
  6. Exchange funding request sent to exchange servers 44
  7. Exchange funding adjustment sent to exchange account 64, response
sent back
  8. Exchange account 64 credited by operating account 62
  9. Patron notified of the successful load
Settlement Flow:
10. Issuing Bank 68 submits settlement details to network N
11. Network N submits settlement details to gateway G
12. Gateway G settlement file sent to network N and processing server 48
13. Reconciliation process at cage 34C sent to transaction server 42
14. Reconciliation details sent to financial database 46
15. Network N sends gateway G settlement details to Fed Reserve FR
16. Fed Reserve FR debits issuing bank 68
17. Fed Reserve FR credits operating account62
18. Settlement file matched w/ reconciliation details
Fee Settlement Flow:
19. Finance team requests funds from Fed Reserve FR
20. Fed Reserve FR Debits provider bank 60 (% of $7 fee)
21. Fed Reserve FR credits casino bank 66 (% of $7 fee)
```

FIG. 2B is a flow diagram which illustrates a process by which a patron may provide funds to a casino cage 34C (such as via chips, currency, coins, etc.) and associate those funds with their exchange. Table 2B sets forth details of transaction flow and settlement of funds flow for such a transaction.

```
TABLE 2B
Transaction Flow:
  1. Patron requests to funds load (e.g. $100 payment to exchange via
cash, chips, card present, ticket, check)
  2. Exchange funding request sent to transaction server 42
  3. Exchange funding request sent to exchange server 44
  4. Exchange funding request sent to exchange account 64
  5. Operating account 62 funds exchange account 64
  6. Patron notified of successful load
Settlement Flow:
  7. Reconciliation process at cage 34C sent to transaction server 42
  8. Reconciliation details sent to database 46
  9. Reconciliation details audited by finance team
10. Finance team requests funds from Fed Reserve FR
11. Fed Reserve FR debits casino bank 68 ($100)
12. Fed Reserve FR credits operating account 62 ($100)
```

FIG. 2C is a flow diagram which illustrates a process by which a patron may access funds from their exchange at a casino cage 34C (such as to obtain currency, coins or chips, etc. from the casino cage). Table 2C sets forth details of transaction flow and settlement of funds flow, for such a transaction.

```
TABLE 2C
Transaction Flow:
  1. Patron Requests withdraw (e.g. $100) from exchange
  2. Exchange funding request sent to transaction server 42
  3. Exchange funding request sent to exchange server 44
  4. Exchange funding request sent to exchange account 64
  5. Exchange account 64 funds operating account 62
  6. Patron funded the requested amount in the requested payment
method (cash, chips, ticket, etc.)
Settlement Flow:
  7. Reconciliation process at cage 34C sent to transaction server 42
  8. Reconciliation details sent to database 46
  9. Reconciliation details audited by finance team
10. Finance team requests funds from Fed Reserve FR
11. Fed Reserve FR debits operating account 62 ($100)
12. Fed Reserve FR credits casino bank 66 ($100)
```

FIG. 2D is a flow diagram which illustrates a process by which a patron may associate funds from a credit card account with their exchange, such as via one of the access or touchpoints 34. Table 2D sets forth details of transaction flow, settlement of funds flow, and fee settlement flow, for such a transaction.

```
TABLE 2D
Transaction Flow:
  1. Patron requests funds (e.g. $100 w/ $7 fee)
  2. Kiosk 34A sends request to gateway G
  3. Fateway G sends request to network N
  4. Network N sends request to issuing bank 68, issuing bank 68
sends response back
  5. Response advise message sent to transaction server 42 from
gateway G
  6. Patron receives authorization confirmation
  7. Patron looks the transaction up at the cage 34C
  8. Cage looks up transaction in transaction server 42
  9. Clearing (completion) request sent to transaction server 42
10. Clearing request sent to gateway G
11. Clearing request sent to network N
12. Clearing request sent to issuing bank 68, issuing bank 68 sends
response back
13. Exchange funding request sent to transaction server 42
14. Exchange funding request sent to exchange server 44
15. Exchange funding adjustment made to exchange account 64,
response sent back
16. Patron notified of the successful load
Settlement Flow:
17. Gateway G Settlement file sent to network N and Everi HQ
18. Reconciliation process at cage 34C sent to transaction server 42
19. Reconciliation details sent to financial database 46
20. Network N sends gateway G settlement details to Fed Reserve FR
21. Fed Reserve FR debits issuing bank 68
22. Fed Reserve FR credits operating account 62
23. Settlement file matched w/ reconciliation details
Fee Settlement Flow:
24. Finance team requests funds from Fed Reserve FR
25. Fed Reserve FR debits operating account 62 (% of $7 fee)
26. Fed Reserve FR credits casino bank 66 (% of $7 fee)
```

FIG. 2E illustrates a flow diagram which illustrates a process by which a patron may associate funds from a debit card account with their exchange, such as via one of the access or touchpoints 34. Table 2E sets forth details of transaction flow, settlement of funds flow, and fee settlement flow, for such a transaction.

```
TABLE 2E
Transaction Flow:
  1. Patron makes funds request (e.g. $100 w/ $7 fee)
  2. Kiosk 34A sends request to gateway G
  3. Gateway G sends request to network N
  4. Network N sends request to issuing bank 68, issuing bank 68 sends
response back
  5. Response advise message sent to transaction server 42 from
gateway G
  6. Patron receives authorization confirmation
  7. Patron looks the transaction up at the cage 34C
  8. Cage 34C looks up and completes transaction in transaction server
42
  9. Exchange funding request sent to transaction server 42
10. Exchange funding request sent to exchange servers 44
11. Exchange funding adjustment made to exchange account 64,
response sent back
12. Patron notified of the successful load
Settlement Flow:
13. Gateway G settlement file sent to network N and processing server
48
14. Reconciliation process at cage 34C sent to transaction server 42
15. Reconciliation details sent to financial database 46
16. Nnetwork N sends gateway G settlement details to Fed Reserve FR
17. Fed Reserve FR debits issuing bank 68
18. Fed Reserve FR credits operating account 62
19. Settlement file matched w/reconciliation details
Fee Settlement Flow:
20. Finance team requests funds from Fed Reserve FR
21. Fed Reserve FR debits operating account 62 (% of $7 fee)
22. Fed Reserve FR credits casino bank 66 (% of $7 fee)
```

FIG. 2F is a flow diagram which illustrates how features of the exchange of the invention may be integrated with and/or utilized relative to online gaming, such as implemented by the casino's online gaming server 28 (such as to allow a patron to utilize funds associated with their exchange in order to fund the online game play). Table 2F sets forth details of transaction flow and settlement of funds flow, for such a transaction.

```
TABLE 2F
Transaction Flow:
  1. Patron requests funds (e.g. $100)
  2. Gaming site 28 sends request to gateway G
  3. Gateway G sends request to transaction server 42
  4. Exchange adjustment request sent to exchange server 44
  5. Exchange balance adjusted in exchange account 64
  6. Exchange account 64 funds operating account 62
  7. Patron issued virtual gaming credits
Settlement Flow:
  8. Reconciliation process at gateway G sends settlement file
to processing server 48
  9. Reconciliation details sent to financial database 46
10. Reconciliation data compared with settlement file
11. Finance team sends settlement details to Fed Reserve FR
12. Fed Reserve FR debits operating account 62
13. Fed Reserve credits casino bank 66
```

FIG. 2G is a flow diagram which illustrates a process by which a patron may cash a check in order to associate funds with their exchange, such as via one of the access or touchpoints 34. Table 2G sets forth details of transaction flow, settlement of funds flow, and fee settlement flow, for such a transaction.

```
TABLE 2G
Transaction Flow:
  1. Patron requests funds load (e.g. load $100 w/ $7 fee) to exchange
from patron bank 68 at touchpoint 34
  2. Touchpoint 34 sends request to transaction server 42
  3. Transaction server 42 sends request to third-party processor TPP
  4. Exchange funding request sent to exchange server 44
  5. Exchange funding adjustment sent to exchange account 64
  6. Exchange account 64 adjusted, response sent back
  7. Patron notified of the successful load
Settlement Flow:
  8. TPP Settlement file sent to processing server 48
  9. Reconciliation process at cage 34C sent to transaction server 42
10. Reconciliation details sent to database 46
11. TPP Bank sends settlement details to FED. Reserve
12. Fed Reserve FR debits patron bank 68
13. Fed Reserve FR credits casino bank 66
14. Settlement file matched w/ reconciliation details at processing
server 48
Fee Settlement Flow:
15. Finance team requests funds from Fed Reserve FR
16. Fed Reserve FR debits provider bank 60 (% of $7 fee)
17. Fed Reserve FR credits casino bank 66 (% of $7 fee)
```

FIG. 2H is a flow diagram which illustrates a process by which a patron may associate funds with their exchange via an ACH transaction, such as implemented at one of the access or touchpoints 34. Table 2H sets forth details of transaction flow, settlement of funds flow, and fee settlement flow, for such a transaction.

```
TABLE 2H
Transaction Flow:
  1. Patron requests ACH transaction (e.g. ACH $100 w/ $7 fee) to
exchange from patron bank 68 at touchpoint 34
  2. Touchpoint 34 sends request to transaction server 42
  3. Transaction server 42 sends request to third-party processor TPP
  4. Exchange funding request sent to exchange server 44
  5. Exchange funding adjustment sent to exchange account 64,
  6. Exchange account 64 adjusted, response sent back
  7. Patron notified of the successful load
Settlement Flow:
  8. TPP settlement file sent to processing server 48
  9. Reconciliation process at cage 34C sent to transaction server 42
10. Reconciliation details sent to database 46
11. TPP bank TPPB sends settlement details to Fed Reserve FR
12. Fed Reserve FR debits patron bank 68
13. Fed Reserve FR credits provider’s bank 60
14. Settlement file matched w/ reconciliation details at processing
server 48
Fee Settlement Flow:
15. Finance team requests funds from Fed Reserve FR
16. Fed Reserve FR debits provider’s bank 60 (% of $7 fee)
17. Fed Reserve FR credits casino bank 66 (% of $7 fee)
```

FIG. 2I is a flow diagram which illustrates a process by which a patron may obtain funds from their exchange via an ACH transaction, such as implemented at one of the access touchpoints 34. Table 2I sets forth details of transaction flow, settlement of funds flow, and fee settlement flow, for such a transaction.

```
TABLE 21
Transaction Flow:
  1. Patron requests ACH transaction (e.g. $100 w/ $7 fee) from
exchange to patron bank 68 at touchpoint 34
  2. Touchpoint 34 sends request to transaction server 42
  3. Transaction server 42 sends request to third-party processor TPP,
response sent back
  4. Exchange funding request sent to exchange server 44
  5. Exchange funding adjustment sent to exchange account 64
  6. Exchange account 64 adjusted, response sent back
  7. Patron notified of the successful load
Settlement Flow:
  8. TPP settlement file sent to processing server 48
  9. Reconciliation process at cage 34C sent to transaction server 42
10. Reconciliation details sent to financial database 46
11. TPP bank TPPB sends settlement details to Fed Reserve FR
12. Fed Reserve FR debits operating account 62
13. Fed Reserve FR credits patron bank 68
14. Settlement file matched w/ reconciliation details at processing
server 48
Fee Settlement Flow:
15. Finance team requests funds from Fed Reserve FR
16. Fed Reserve FR debits operating account 62 (% of $7 fee)
17. Fed Reserve FR credits casino bank 66 (% of $7 fee)
```

FIG. 2J is a flow diagram which illustrates a process by which a patron may obtain funds from their exchange via an original credit transaction (OCT), such as via one of the access or touchpoints 34. Table 2J sets forth details of transaction flow, settlement of funds flow, and fee settlement flow, for such a transaction.

```
TABLE 2J
Transaction Flow:
  1. Patron requests OCT transaction (e.g. $100 w/ $7 fee) from
exchange to patron bank 68 at touchpoint 34
  2. Touchpoint 34 sends request to transaction server 42
  3. Transaction server 42 sends request to third-party processor TPP,
response sent back
  4. Exchange funding request sent to exchange server 44
  5. Exchange funding adjustment sent to exchange account 64
  6. Exchange account 64 adjusted, response sent back
  7. Patron notified of the successful load
Settlement Flow:
  8. TPP settlement file sent to processing server 68
  9. Reconciliation process at cage 34C sent to transaction server 42
10. Reconciliation details sent to financial database 48
11. TPP bank TPPB sends settlement details to Fed Reserve FR
12. Fed Reserve FR debits operating account 62
13. Fed Reserve FR credits patron bank 68
14. Settlement file matched w/ reconciliation details at processing
server 48
Fee Settlement Flow:
15. Finance team requests funds from Fed Reserve FR
16. Fed Reserve FR debits operating account 62 (% of $7 fee)
17. Fed Reserve FR credits casino bank 66 (% of $7 fee)
```

FIG. 2K is a flow diagram which illustrates a process by which a patron may utilize their exchange to pay for a retail transaction (such as for goods/services from a casino's retail establishment 32). Table 2K sets forth details of transaction flow, settlement of funds flow, and fee settlement flow, for such a transaction.

```
TABLE 2K
Exchange Enrollment:
  1. Patron goes to cage 34C to enroll in the exchange
  2. Cage sends enrollment request to transaction server 42
  3. Enrollment request sent exchange server 44
  4. Exchange account 64 created and response sent to Patron
Exchange Registration:
  1. Patron downloads app
  2. Patron registers mobile device with exchange account 64 and patron
profile in transaction server 42
Transaction Flow:
  1. Patron requests retail purchase(e.g. $100 retail purchase) using
mobile tap with discover token
  2. Purchase request sent to card network
  3. Purchase request sent to third party processor TPP
  4. Purchase request sent to restricted access network, response is
provided back
  5. Purchase approval request sent to transaction server 42
  6. Approval request sent to exchange server 44
  7. Funds deducted from exchange account 64, response sent back to
mobile device
  8. Transaction advise message sent to database 46
Settlement Flow:
  1. Settlement details sent to processing server 48 from card network
bank
  2. Settlement details sent to processing server 48 from third party
processor sponsor bank
  3. Settlement details extracted from database 46 to processing server 48
  4. All settlement details compared together
  5. Funding request sent to Fed Reserve FR
Funding Flow:
  1. Card network bank funds mmerchant’s bank through Fed Reserve
Bank FRB based on settlement details
  2. Sponsor bank funds card network bank through Fed Reserve Bank
FRB based on settlement details
  3. Provider bank 60 funds sponsor bank based on settlement details
```

FIG. 2L is a flow diagram which illustrates a process by which a patron may transfer funds to their exchange via an automatic funds transfer (AFT) process, such as via one of the access or touchpoints 34. Table 2L sets forth details of transaction flow, settlement of funds flow, and fee settlement flow, for such a transaction.

```
TABLE 2L
Transaction Flow:
  1. Patron requests AFT of funds (e.g. AFT $100 w/ $7 fee) to
exchange from patron bank 68 at touchpoint 34
  2. Touchpoint 34 sends request to transaction server 42
  3. Transaction server 42 sends request to third-party processor TPP,
response sent back
  4. Exchange funding request sent to exchange server 44
  5. Exchange funding adjustment sent to exchange account 64
  6. Exchange account 64 adjusted, response sent back
  7. Patron notified of the successful load
Settlement Flow:
  8. TPP settlement file sent to processing server 68
  9. Reconciliation process at cage 34C sent to transaction server 42
10. Reconciliation details sent to financial database 48
11. TPP bank TPPB sends settlement details to Fed Reserve FR
12. Fed Reserve FR debits patron bank 68
13. Fed Reserve FR credits operating account 62
14. Settlement file matched w/ reconciliation details at processing
server 48
Fee Settlement Flow:
15. Finance team requests funds from Fed Reserve FR
16. Fed Reserve FR debits operating account 62 (% of $7 fee)
17. Fed Reserve FR credits casino bank 66 (% of $7 fee)
```

It will be appreciated that the transaction amounts, including the fee amounts or percentages, which are identified in the examples above are merely examples and may vary.

It will now be appreciated that in accordance with one embodiment of the invention, the system 20 comprises or implements an electronic financial exchange. This exchange facilitates financial transactions in a casino environment, relative to funds held by a patron in an external banking network, such as an at exchange account 64 at a bank of the financial provider. The exchange facilitates processing of the requested transaction (such as a request for funds at a casino, to transfer funds to a gaming machine or the like) and effectuates the transaction by causing a movement of funds in the banking network, such of funds of the patron in the exchange account 64 to another account, such as a casino's bank account at the casino's bank. Of course, as indicated above, the movement of the funds may depend upon the requested transaction. In this regard, other processes may be implemented using the system of the invention, including other types of transfers from a patron's source of funds to associate funds with their exchange (via their exchange account 64) to obtain funds, fund wagering or pay for transactions.

Patron Exchange and Associated Applications

As indicated above, the casino financial services system 20 may enable a wide variety of financial transactions in or relating to a casino environment, such as via a patron's exchange. As detailed herein, these transactions may comprise, but are not limited to: a) associating funds with a patron's exchange (including, but not limited to, from external sources (such as credit/debit cards, bank accounts, crypto currency wallets, financial wallets (Apple PAY), etc.) or from casino sources (gaming machines, kiosks, gaming tables, markers or credit lines)) and b) transferring funds from a patron's exchange (such as to external locations (such as credit/debit cards, bank accounts, crypto-currency wallets, financial wallets, etc.) or to casino-related locations (gaming machines, tables, retail locations, kiosks, to pay of a marker/credit line, etc.)). Of course, the patron's exchange might be linked to various other account or elements, including, but not limited to: PayNearMe, PayPal, Raise.com, etc. As described herein, the casino-related locations may comprise locations which are associated with different infrastructures, such as to comply with applicable regulations for the location, including gaming, PCI, PII, internal controls, AML and banking, which vary from location to location.

In one embodiment, a patron might request the creation of an exchange by the financial provider FP, such as via one of the touch or access points 34. For example, a patron might request the creation of an exchange via a kiosk 34A located in the casino C, via their personal device (such as a personal mobile device 34B), such as by downloading an application onto their device 34B (e.g. a downloadable or installable software application, such as a mobile application) which both permits them to create an exchange and then utilize/access their exchange, via casino cage or other sign-up location, etc. When such a request is received, the financial provider FP may request personal information from the patron (and/or obtain such information from other sources, such as a player tracking system of the casino C) to create an exchange for the patron. This exchange may comprise, for example, a ledger or file which is maintained by the financial provider FP via the exchange server 44 which reflects a balance of funds of the patron in the exchange account 64 at the financial institution.

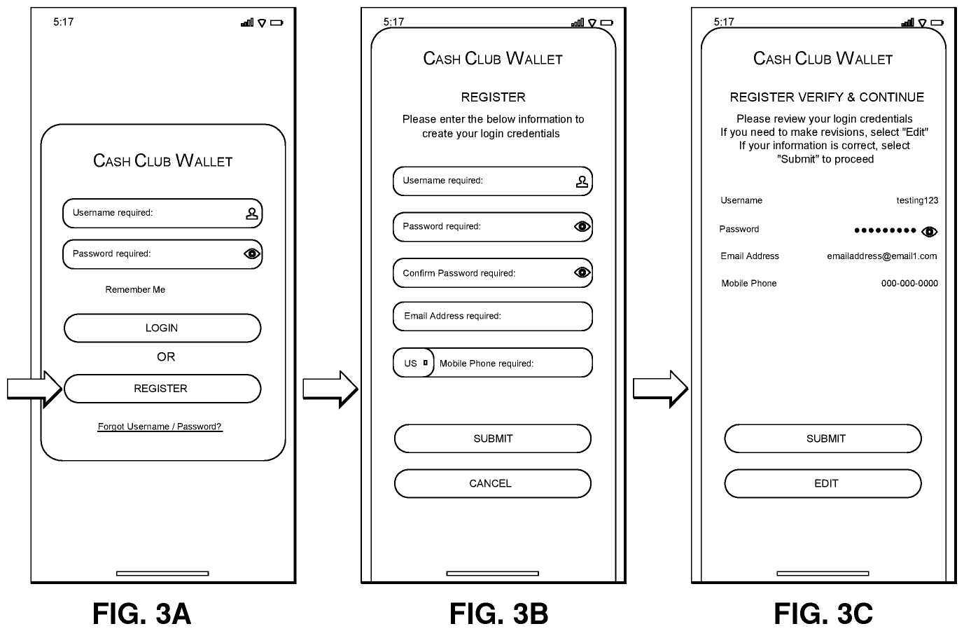

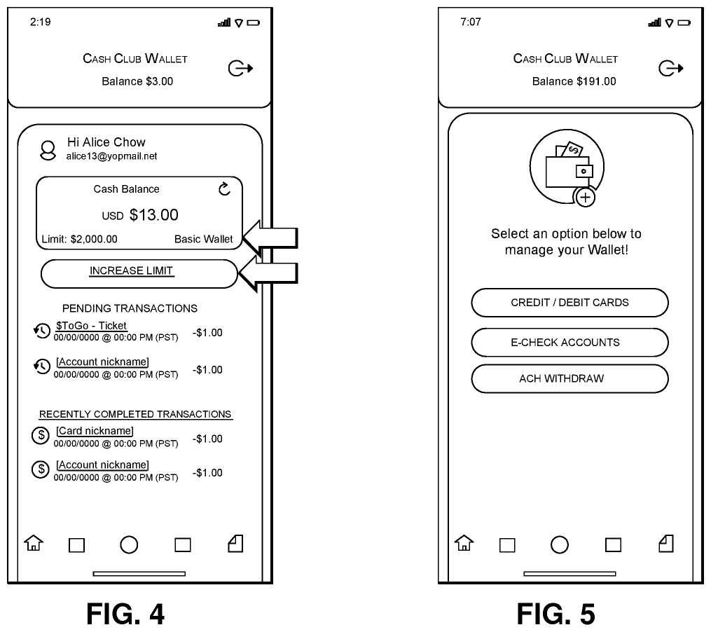

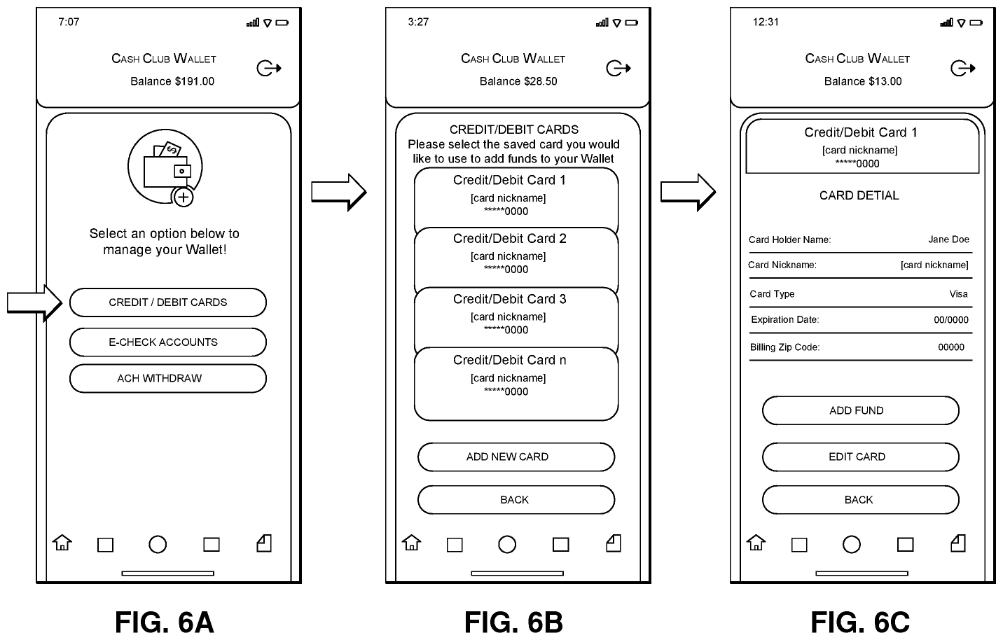

As illustrated in FIGS. 3A-C, interfaces may be presented by implementing the exchange application which allows a patron to create an exchange and implement exchange functionality therewith. The creation of an exchange may comprise the steps of receiving (such as by the graphical interface by one or more input devices of the patron's device) patron identifying information and inputting or generating a user name and password, where the creation or registration may include secondary authentication, such as the transmission of a verification code to the patron via text and/or email, which code the patron has to input for validation purposes, as illustrated in FIGS. 3B and 3C. The patron may be required to provide various personal information, billing address information and/or other information in order to generate the patron's exchange and this information may be stored in a database, such as in association with the exchange server 44.

In one embodiment, as illustrated in FIG. 4, the patron may utilize their exchange to obtain or access exchange information (such as after logging into the application, such as by input of the patron's user name and password). The exchange information may comprise, for example, a wallet funds balance. The exchange information might also comprise information regarding pending transactions and/or completed transactions.

In one embodiment a patron may utilize the various access or touchpoints 34 in order to engage in financial transactions, such via their exchange, as described below. For example, a patron might go to a kiosk or a casino cage at the casino C in order to initiate a requested transaction, such as to associate funds with their exchange (as implemented via the exchange account 64) or withdraw funds using their exchange (as implemented via the exchange account 64). In the case of a kiosk 34A, if the patron is seeking to withdraw funds, the kiosk might dispense currency and/or coins to the patron or might issue a value ticket (such as a game ticket having associated value, where the patron may then either redeem that ticket for cash or may provide it to a gaming machine 24, etc., in order to associate funds therewith). In the case of a casino cage, the patron might be provided with currency and/or coins, chips, a gaming value ticket or other indicia of value for the requested funds.

As indicated, one of the touchpoints may comprise the patron's mobile device 34B, whereby the patron may use that device to request a desired transaction or otherwise manage their exchange. For example, as illustrated in FIG. 5, a patron may manage credit or debit cards associated with their exchange, e-check accounts associated with their exchange and/or ACH withdrawals, among other options. Managing these features may comprise, for example, adding new credit or debit cards (e.g. whereby they are linked with the patron's exchange and can be used in transactions by which funds are moved from an external account associated with a credit or debit account to the patron's exchange, or by which funds may be moved from the exchange to the credit or debit account, etc.). For example, as illustrated in FIGS. 6A-C, by selecting a “credit/debit cards” option (as in FIG. 6A), another interface may be displayed of all currently linked credit/debit cards, as illustrated in FIG. 6B. As indicated, the patron might have the option of adding a new card. The patron might also select one of the linked cards, whereby another interface may be displayed (as at FIG. 6C) which allows the patron to edit/manage that card, as well as add funds to the exchange from that card (where a patron may be prompted for information regarding the desired amount of the transaction, etc.).

As indicated above, the casino financial services system 20 may allow a patron to access funds for use within the casino, such as via various touch-points. In one embodiment, a patron may access funds associated with their exchange via a kiosk 34A or similar device, including via use of their mobile device 34B and associated exchange application. In one embodiment, the patron may utilize the exchange application in order to request funds in the form of a value ticket or cash, which value ticket or cash may be dispensed/obtained from one of the kiosks 34A (and which the patron may then use in various transactions in the casino C, such as funding gaming, paying for retail transactions, etc.)

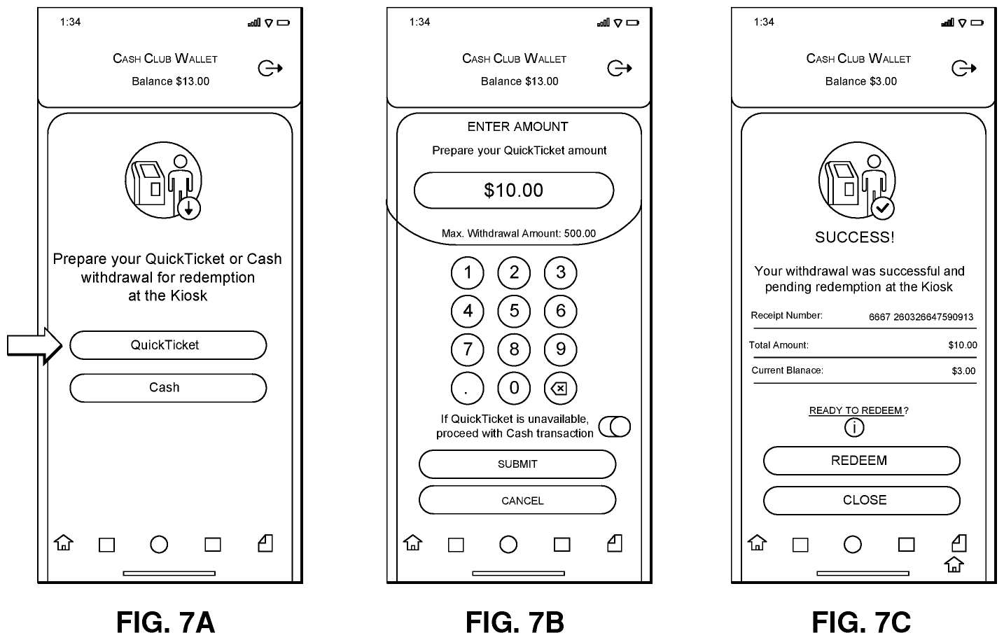

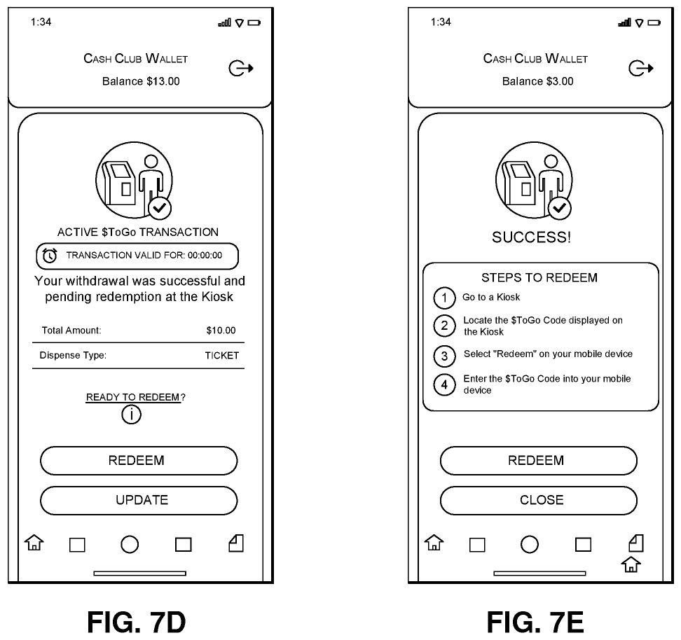

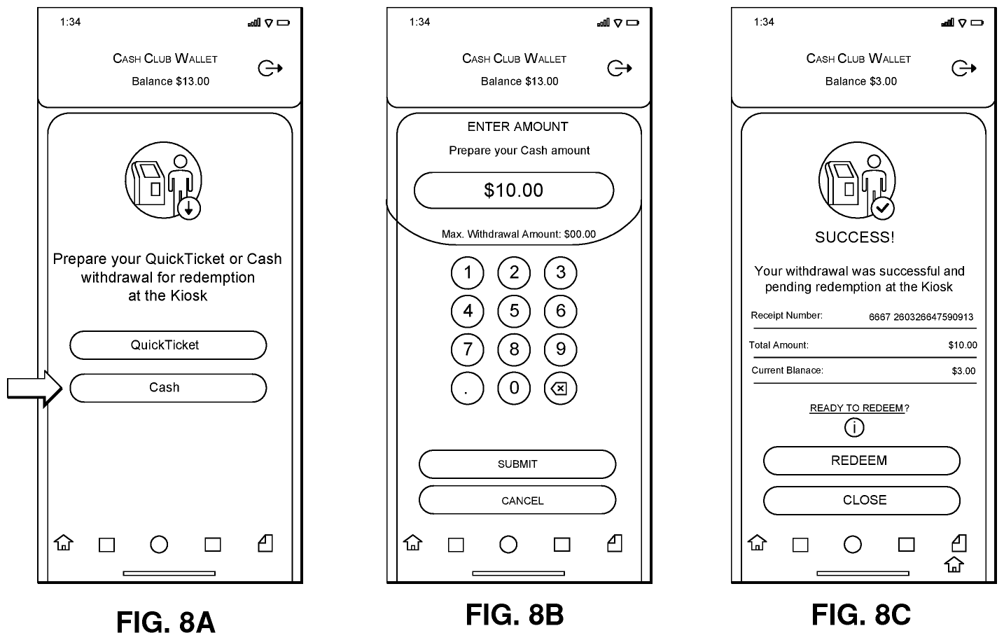

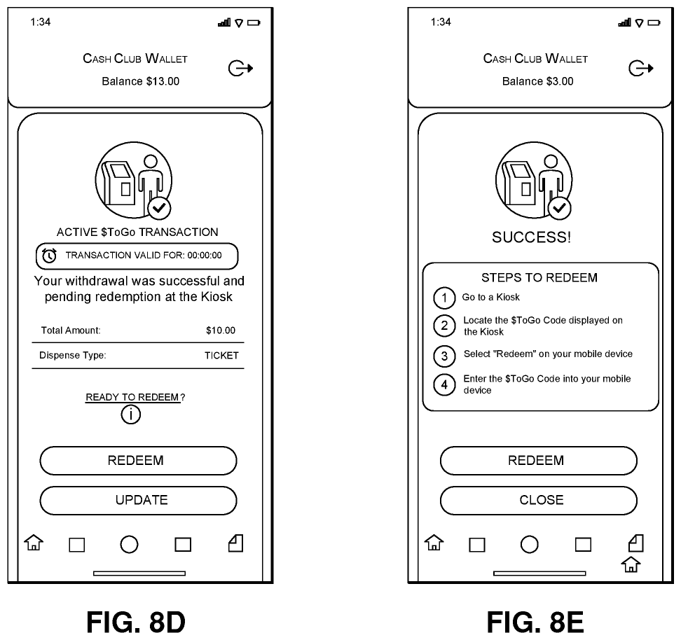

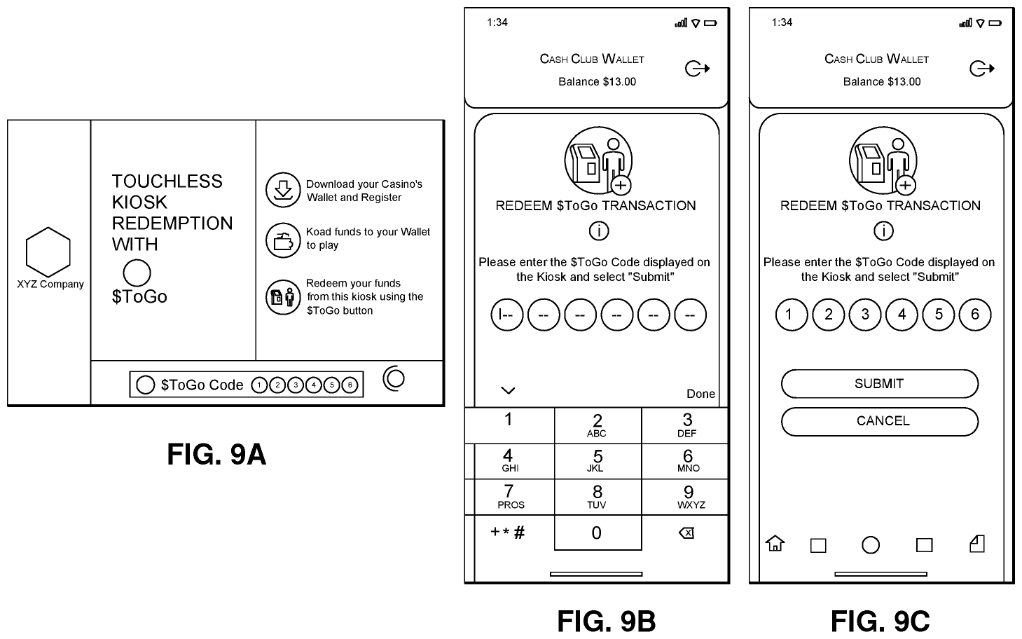

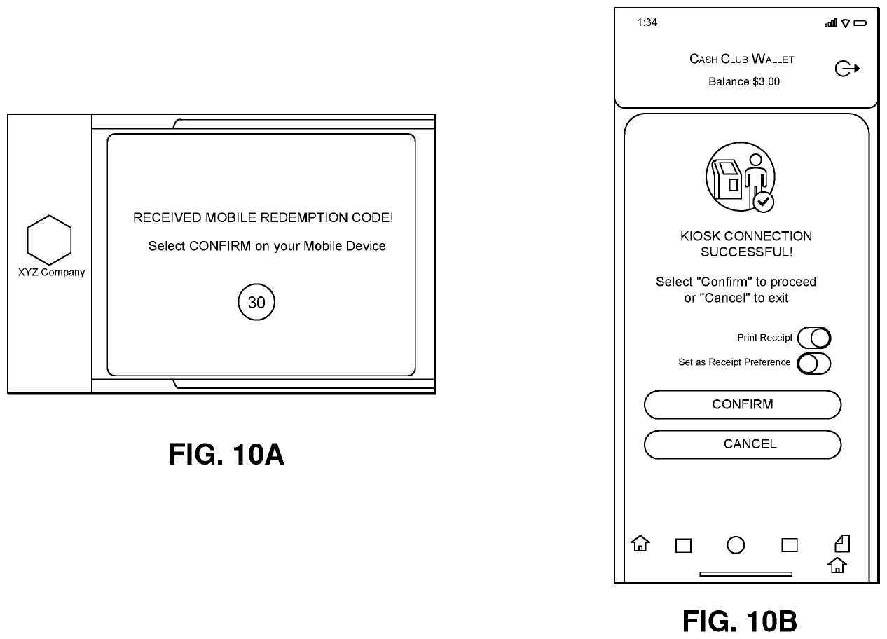

FIGS. 7A-E illustrate a sequence of graphical interfaces that may be displayed to a patron via their mobile device 34B running an exchange application of the invention. This sequence of transactions allows the patron to request a value ticket in an amount of funds associated with their exchange. In this example, the patron has requested a ticket in the amount of $10.00. The exchange application may communicate with the transaction server 42 (which is in communication with the exchange server 44) to process the transaction. As indicated, when the transaction is approved, the patron is instructed to travel to a kiosk 34A (or similar location where a value ticket may be dispensed) to complete the transaction.

FIGS. 8A-E illustrate a sequence of graphical user interfaces that may be displayed to a patron via their mobile device 34B running an exchange application of the invention. This sequence of transactions allows the patron to request a cash (preferably in the form of currency) in the amount of funds associated with their exchange. Once again, the exchange application communicates with the transaction server 42 (which is in communication with the exchange server 44) to process the transaction. As indicated, when the transaction is approved, the patron is instructed to travel to a kiosk 34A to complete the transaction.

As illustrated in FIG. 9A, the patron may engage a kiosk 34A to complete the above-described transactions. Preferably, as illustrated in FIG. 9A, the kiosk 34A may display an interface which provides information to the patron about how to complete the transaction. In one embodiment, the kiosk 34A displays a confirmation code to the patron. This code preferably changes for each transaction at each kiosk—thereby being unique to each transaction. As illustrated in FIGS. 9B and 9C, the exchange application running on the mobile device 34B of the patron may be configured to display an interface via which the patron inputs to the mobile device 34B the confirmation code. This code is transmitted back to the transaction server 42 which confirms the code against the code displayed by the kiosk 34A, thus effectively linking or confirming the patron to that particular kiosk 34A. In particular, as illustrated in FIGS. 10A and B, once the confirmation is verified, a notification may be provided to the patron via the kiosk 34A and via their mobile device 34B. The patron may then, as indicated in FIG. 10B, confirm that they wish to complete the desired transaction. If so, the kiosk 34A then completes the transaction, such as by printing/dispensing a value ticket in the amount of the requested funds, or by issuing cash (currency) to the patron.

It will be appreciated that a similar flow of interaction (such as via the kiosk 34A and the exchange application on the patron's mobile device 34B) may be similarly implemented in order to facilitate a deposit of funds (such as by transferring funds from a monetary value gaming ticket held by the patron to their exchange, such as for use in other transactions or for further transfer to their checking or savings account, etc.)

As indicated herein, various other transaction types and/or features may be enabled via the system 20.

As one example, a patron might link their Apple PAY wallet to their exchange, which Apple PAY wallet may have various associated accounts, such as credit cards. The patron might thus use the exchange (such as via the exchange application running on their mobile device 34B) to effectuate a transfer of funds from one of their Apple PAY sources to their exchange, thus making those funds available for use in the casino C (wherein such a transaction involves a transfer of funds from the patron's Apple PAY wallet to the exchange account 64 via the banking system, via request from the financial server 42).

Integrated Credit Generation and Association

As yet another embodiment, a patron might be permitted to open or obtain a new credit card which is linked to their exchange. For example, at the time a patron seeks to enroll, the patron might be presented the option to simultaneously apply for a credit card and that card may be linked to their exchange. Alternatively, the patron might apply for such a credit card, such as via the exchange application running on their mobile device 34B. Once the credit card has been approved, the patron might seek to move funds from that card to their exchange, such as for use in paying for retail transactions, funding game play, etc., as otherwise described herein. In one embodiment, such a credit card might be a preferred or branded card which is offered by the casino C. In some embodiments, the patron might manage that card via the system 20, including the exchange application, such as to make payments for credit obtained from the card, etc.

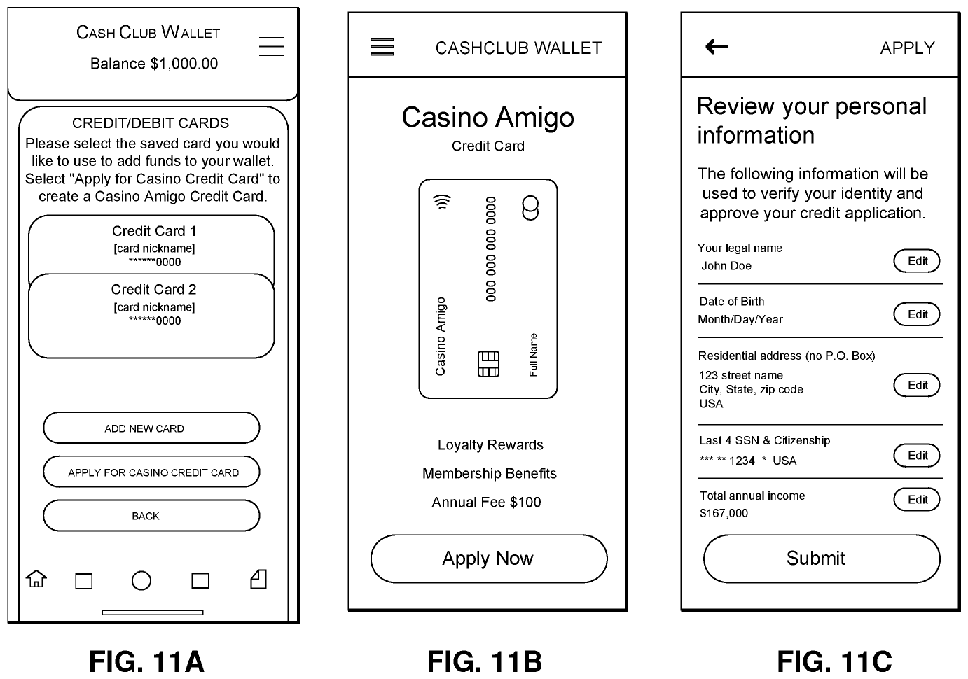

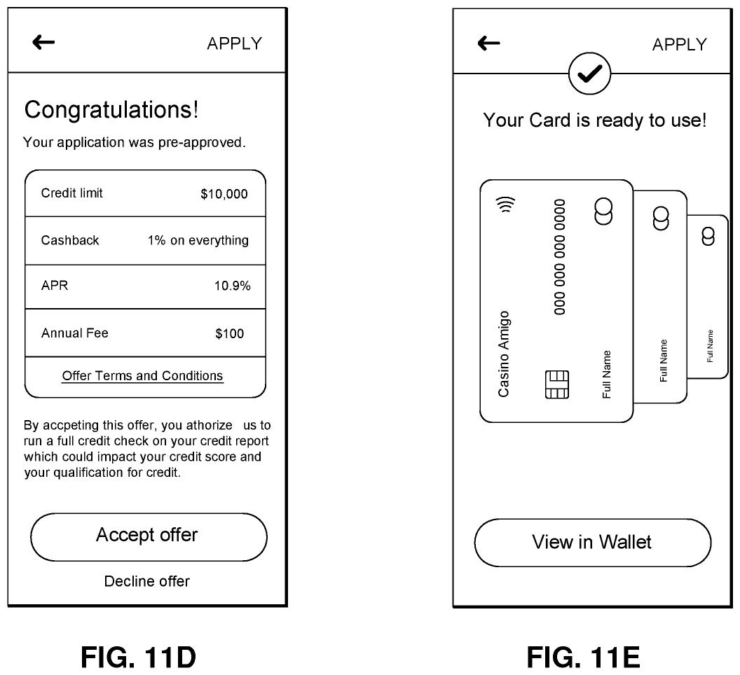

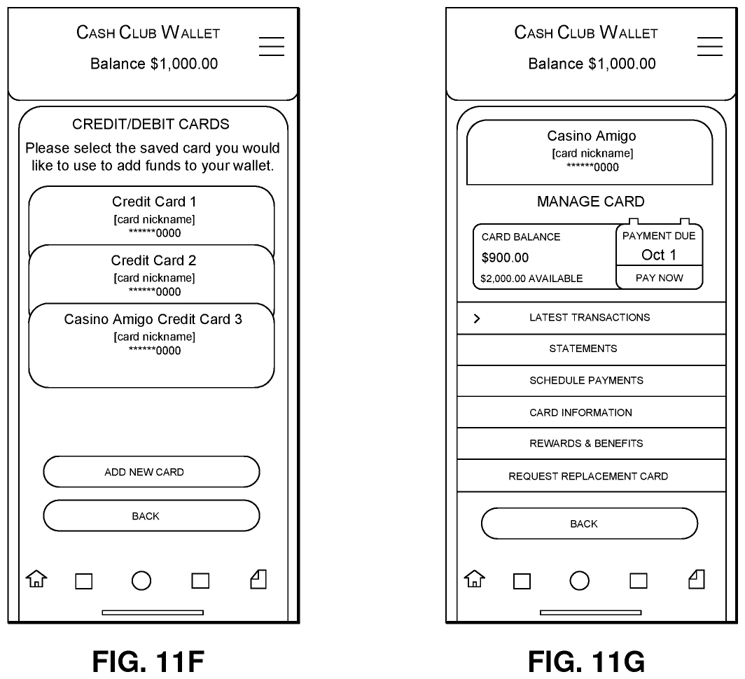

FIGS. 11A-G illustrate a sequence of graphical user interfaces that may be displayed to a patron via their mobile device 34B running an exchange application of the invention relative to such a process.

As illustrated in FIG. 11A, a displayed graphical user interface may present a patron with the option to “Apply For Casino Credit Card.” In the event the patron provides input to such a selection, another interface may be displayed which provides details of the credit offer, such as illustrated in FIG. 11B. This interface may include a further request for input from the patron to continue with the offer.

As illustrated in FIG. 11C, if the patron continues with the offer, the application may present an interface which is configured to receive input of patron information, such as which is used to verify the credit-worthiness of the patron and generate a patron credit account. In one embodiment, information regarding the patron may be obtained from one or more sources and may be associated with the application. For example, the player's name, address and other contact information may be obtained from the information database 46. This information may be filled into fields of the credit application and displayed to the patron. In cases where information is not available to self-fill into the application, the patron may be prompted to provide the requested information.

In one embodiment, information regarding the patron is utilized to determine the credit-worthiness of the patron, including whether to issue credit and, if so, the amount of credit (e.g. the amount of the credit line). In one embodiment, the credit may be associated with a bank credit card, such as branded to the casino that is implementing the exchange. Thus, in one embodiment, the operator of the exchange may transmit the patron's credit application (e.g. the patron information) to the bank (such as a computer or system associated with the bank) for review and a response.

As illustrated in FIG. 11D, the application may be configured to present information regarding the results of the credit application. In some embodiments, the results may indicate a denial of the request. In others, the results may comprise an acceptance with an credit line offer having specific terms. As illustrated in FIG. 11D, in such an event, the information may include details regarding the credit terms. In such an embodiment, the patron may be permitted to accept or deny the credit offer. If the offer is denied, the patron may be returned to the another interface, such as the one illustrated in FIG. 11A. If the patron provides input accepting the credit offer, the credit account may be linked to the patron's exchange account and an indication of such may be provided, such as illustrated in FIG. 11E.

As illustrated in FIG. 11F, the application may then cause the patron's exchange to include an indication of the newly generated credit card or account therewith, such as along with any other credit or debit cards. The patron may then selected the newly created credit card or account, such as to access funds therefrom and/or to otherwise manage that account, such as illustrated in FIG. 11G.

In accordance with this aspect of the invention, a casino patron is offered a source of funding for casino-related activities, including gaming and non-gaming activities. The source of funding may comprise a bank credit account. Advantageously, the credit offer may be integrated with the patron's exchange account so as to be available to the patron during creation of the exchange, or at a later time. In one embodiment, the credit offer may be branded to match the casino with which the exchange is associated. The credit application process may utilize information which is used to generate the exchange and/or which is stored in association with the exchange, thus eliminating the need for the patron to provide the same information at different times for different purposes. Further, the generated credit account is automatically associated with the patron's exchange, thus eliminating the need for the patron to manually associate that account, or others, with their exchange in order to have a source of funds associated therewith. An advantage of this feature of the invention is that a patron may obtain a new retail credit card account from an external credit card issuer (such as an external bank), but where that credit card is linked to their patron exchange, where the patron exchange effectively servers as a financial services hub, allowing integration and management/use of the external retail credit card via the patron exchange. In this regard, in one embodiment, in accordance with this feature, the credit card is approved, issued and provisioned to the patron via their mobile device in real time, as opposed, for example, to existing methodologies in which a patron may be required to apply for a credit card which is processed remotely and mailed to them and which the patron then has to manually associated with other accounts, which may take days or weeks.

Additional Details

In a preferred embodiment of the invention, financial services functionality is integrated into existing devices and systems, such as those of a financial provider FP and a casino C. This avoids creating an entirely separate system in order to enable financial transactions, whether via accounts or in other manners. Instead, in this embodiment, transactions are digitized and essentially become a new channel within the existing systems, so as to be fully integrated with the existing systems of the financial provider FP and the casino C.

For example, a casino C may have multiple existing casino cages 34C, gaming machines 24, gaming tables 26, a slot management system 30, etc., along with one or more kiosks 34A and a back-end transaction server for processing transactions at the kiosks and casino cage. In accordance with the invention, the casino financial service system 20 may be overlaid onto these existing devices and communication pathways. For example, by implementing an exchange server 44, the casino financial services system can process exchange account-based transactions made by a patron via a kiosk 34A, or may facilitate the transfer of funds from a patron's bank account to a gaming machine 24 (for funding wagering), and the like.

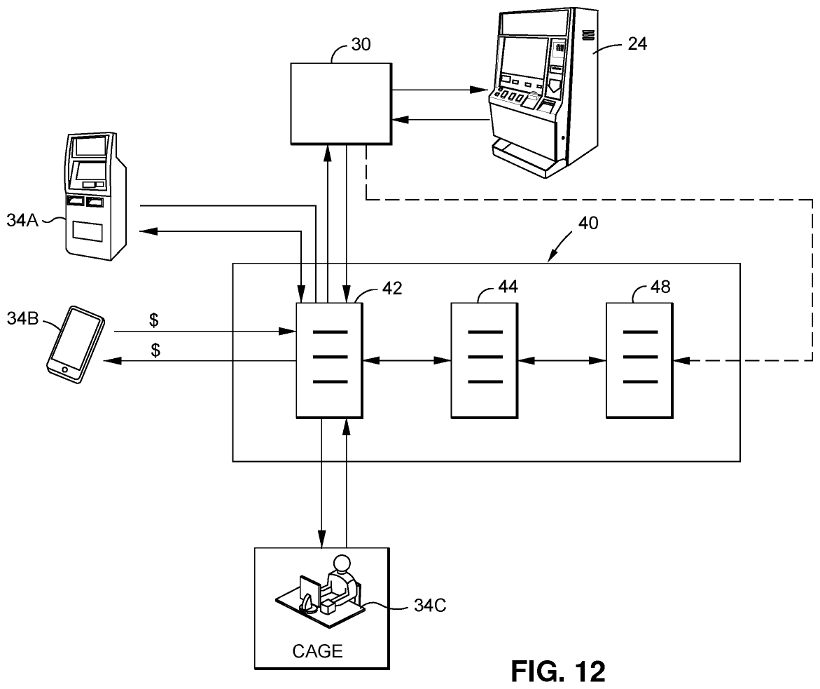

For example, FIG. 12 illustrates aspects of the casino financial services system 20 as integrated with or interfacing to slot management system 30 (such as a third party wagering system which the casino C utilizes to manage associated gaming machines 24). In this configuration, the financial provider's system 40 is connected to or communicates with the slot management system 30 (such as by one or more APIs). The slot management system 30 may facilitate, for example, movement of funds onto and off of an individual gaming machine 24.

By interfacing the financial provider's system 40 with the slot management system 30, a patron may transfer funds from their exchange to a gaming machine 24, such as to fund wagering at the gaming machine. In another embodiment, credits associated with a gaming machine 24 (such as previously associated with the machine or won by the patron) may be moved from the gaming machine to their exchange. In one embodiment, the credits are converted to monetary value as part of this process (e.g. 100 credits at a gaming machine that each have a $0.25 value are transferred to the exchange as $25.00. As illustrated in FIG. 12, the slot management system 30 may transmit information to the processing server 48 (directly or indirectly, such as via transaction information to the transaction server 42) which can be used for reconciliation purposes (including relative to the slot management system's 30 accounting for funds-in and out and/or for other purposes, such as AML or SAR reporting as detailed below).

The funds transactions might be initiated in various manners. For example, in one embodiment, a patron may utilize their mobile device 34B, such as running an exchange application of the invention, to request such a transaction. In one embodiment, a patron who is located at a gaming machine 24 may connect or sync their mobile device 34B to the gaming machine as at flow S. This may comprise, for example, placing the mobile device 34B into communication with the gaming machine 24 via a communication interface of the mobile device 34B and the gaming machine 24 (such as via a wireless links such as Bluetooth, Wi-Fi, NFC or a wired link). In one embodiment, the syncing may involve one or more validation features or elements, such as the requirement to enter a validation code or the like. This step is preferably utilized to effectively identify the particular gaming machine 24 which the patron is utilizing and that the transaction is to be effectuated with.

The patron may then request a funds transaction with that gaming machine 24, such as via their mobile application running on their mobile device 34B. For example, the patron might use the exchange application to request that an amount of funds associated with their exchange be transferred to the gaming machine 24. This request may be received by the transaction server 42 which processes the transaction in conjunction with the exchange server 44. The transaction server 42 may provide instructions to the slot management system 30 to associate the funds with the particular gaming machine 24. The slot management system 30 may, for example, receive information regarding the funds to be added to the gaming machine 24 and then transmit instructions to the gaming machine 24, such as via a slot account system (SAS) protocol (of IGT, Reno, Nev.) to cause a credit meter of the gaming machine 24 to increment by the amount of the transferred funds. Likewise, the patron might request that monetary value credits associated with a gaming machine 24 be moved from the gaming machine back to their exchange, in a similar manner.

In one embodiment, the processing server 48 or other devices or systems may implement additional financial services functionality. For example, the processing server 48 may implement one or more of AML (anti-money laundering) tracking and reporting, SAR (suspicious activity) tracking and reporting and the like. For example, the processing server 48 may receive transaction information from one or more systems or devices, such as a casino's slot management system 30 (see FIG. 51), from the transaction server 42 in relation to transactions performed at kiosks 34A and casino cages 34C and the like.

Most preferably, when financial transactions of the system 20 are processed, they may flow through or be reported to the processing server 48, such as for processing by the AML and/or SAR system. This is important because a patron's financial transactions (including exchange transactions) can then be viewed or analyzed with other of the patron's transactions, such as jackpots, amounts wagered, etc., as part of detecting potential money laundering or other suspicious activities.

As another example, the processing server 48 and/or other servers or devices may implement patron tracking and/or loyalty functionality. This functionality may comprise tracking the activities of a patron at the casino C, such as amounts wagered at gaming machines and tables, spent on retail, etc. In accordance with the present invention, this tracking functionality can be enhanced by tracking funds moving through the patron's exchange, such as amounts deposited and amounts removed therefrom, including the sources and destinations.

It is noted that while certain aspects of the invention have been described and illustrated relative to a single casino C, various aspects of the invention may apply to multiple casinos. As one example, an operator might operate two or more casinos. In that event, the transactions associated with those two or more casinos may be processed jointly, such as by a single back-end provider (such as by one transaction server 42 and exchange server 44 or sets of such servers, operated the provider). In this manner, a patron of a first casino might utilize their exchange to fund gaming, pay for retail purchases or the like, and then the patron might travel to a second casino and use the same exchange to fund gaming, pay for retain purchases or the like.

Multi-Jurisdiction Adaptive or Dynamic Rules

In accordance with one aspect of the invention, the casino financial services system 20 is configured to implement adaptive or dynamic rules. In one embodiment, the casino financial services system 20 is configured to implement one or more rules based upon a location of the financial transaction. The rules may comprise a plurality of rules or rule sets, wherein rules are tied or associated with one or more geographic locations. The one or more geographic locations may comprise regions, countries, states, individual casinos, sub-locations or areas within a single casino, or other locations (which may be user defined or might be defined, such as in the cases of the boundaries of a county/state, by a third party).

In one embodiment, the one or more rule sets are applied to transactions based upon the location of the transaction and are utilized to process (which in some cases may be to deny processing) of a transaction. Without limitation, the rule sets or rules may, for example, define: (a) transaction velocity limits; (b) transaction limits by type of transaction, such as transactions associated with credit vs. debit cards; (c) responsible gaming limits or controls; (d) casino controls, or others.

The one or more rule sets are stored and are preferably applied, such as by the transaction server 42 and/or exchange server 44, when a transaction is requested. In one embodiment of the invention, when a transaction is requested or triggered, the location of the transaction is determined. For example, when a transaction is requested from a touchpoint 34, the location of that touch point is determined or obtained (for example, relative to a transaction requested by a patron by their mobile device 34B, the location of the mobile device 34B might be obtained in various manners, such as by the exchange application running thereon obtaining triangulated cell location information, by GPS or otherwise, when the transaction is initiated at a kiosk 34A, POS 34E or the like, the location of that device may be obtained, such as by retrieval from a database in which the location of the device is stored).

The one or more rules or rule sets are then applied to the transaction based upon the determined or identified location. In one embodiment, multiple rule sets may be applied. For example, a first rule set may define transaction limits in a state A. However, there may be two casinos at different locations in state A, where casino #1 has a first responsible gaming limit and casino #2 has a second responsible gaming limit. If the transaction is being implemented at casino #1, the first rule set relating to state A, and then the second rule set defining the first responsible gaming limit at casino #1 within state A, would apply.

In one embodiment, rules or rule sets may be applied in an order or hierarchy, such as based upon the particular type of rule. For example, if casino #1 has a responsible gaming limit of $10,000 per day on debit transfers for its patrons, but state A has a regulation which limits debit transactions at casinos in the state to $5,000 per day per patron, then the rule associated with the regulation would override the casino's responsible gaming limit.

In one embodiment, rules or rule sets may be stored in one or more databases and may be updated or modified. As indicated, the database preferably includes location information tied to each rule or rule set.

User Driven Controls

As one aspect of the invention, the integrated financial services system allows for the implementation of user driven controls. Those controls might be set by the patron and/or the casino (or a third party, like the financial services provider/vendor). These user driven controls may, for example, be associated with their exchange and thus be applied or implemented by the exchange server 44 (and/or the transaction server 42).

The user driven controls may be input or selected in various manners. For example, the exchange application may include one or more interfaces which allow a patron to make selections of patron-selected controls.

As one example, a patron might select whether they wish to receive mobile alerts (such as text message alerts) when certain activities are detected. For example, those activities might comprise one or more of: a) use/access of a credit or debit card; b) use of an e-check; c) digital currency deposits; d) ACH withdrawals, e) mobile to kiosk transactions; f) games activity; g) retail activity; h) kiosk activity; and/or i) cashier-related activity. In one embodiment, the patron might elect to receive alerts in response to any one or more (or none) of these events or activities. If selected, when the system detects one of the selected activities, the patron may be alerted (such as by the generation and transmission of a text message alert to the patron's mobile device 34B). The patron can preferably disable alerts and/or modify alerts.

In one embodiment, a patron may also be permitted to enable email alerts. Email alerts may simply be different communication pathway to the provision of text alerts. In another embodiment, the email alerts might comprise other types of alerts. For example, a patron might be permitted to elect to receive daily, weekly or monthly emails that provide details or summaries of activities or alerts for a particular day, week or month.

As another example of a user-driven setting, a patron might be permitted to select a card or account limit. Such a limit may represent a maximum funds (such as US$) limit upon transaction associated with a particular credit card during a particular period of time (where the period of time might be selectable and might comprise, for example, 1 day, 7 days, 30 days or the like). In one embodiment, the patron may be permitted to select the limit for individual credit cards or all cards. The patron may also update or change the account limits.

As one example of the implementation of such a user-driven control, a patron might set a $1000, 1 day limit upon a credit card the patron has linked to their exchange. The patron might seek to move $500 from their credit card to their exchange via their mobile application. The financial server 42 would receive the request and the exchange server 44 would confirm that the requested $500 is within the patron's set $1000 limit and thus process the transaction. The patron might then several hours later seek to move $700 from that same credit card to their exchange. In that instance, the exchange server 44 would block the transaction (or at least the portion above the $1000 limit).

A patron might similarly be permitted to select limits on mobile deposits (such as via eCheck, debit card) or other types of transactions.

Of course, the patron might be permitted to select or enable other controls (various velocity controls such as individual and/or aggregate limits upon amounts of funds during various periods of time, from individual and/or aggregate sources), location controls (such as limitations upon the use of funds or activities at certain locations), etc.

Likewise, the casino or financial services provider might implement user-driven controls. The various rules or controls might overlap (and a hierarchy may be applied to them). For example, a casino might apply a $1000 per day funds limit upon all of their patron account (such as for credit card funding to their exchange). Thus, even if a patron had set a $2000 limit, the casino's $1000 limit might override.

Certain user-driven controls or limits may be based upon laws or rules, such as regulatory rules, law relating to currency transfers, etc.

Funds Transaction Types and Sources

As described above, the casino financial services system 20 facilitates a wide variety of transactions at a casino, including relative to external funds sources or accounts. Such may comprise bank accounts (checking/savings), credit accounts and the like.

In some embodiments, a patron may seek casino credit, such as in the form of a casino marker. Such a casino marker generally comprises a negotiable instrument that can be redeemed for cash or cash-equivalent. For example, a patron might seek a marker from the casino (which might be processed by the casino C or a third party, such as the financial provider). This may include running a credit check on the patron, obtaining collateral or other features, as is known in the art. In accordance with the invention, however, instead of providing cash or casino chips to the patron, the funds associated with a marker may be deposited into their exchange (placed in the exchange account 64). The patron may then use those funds in the manners described herein, such as via various touch points 34, and for various purposes. Further, restrictions may be placed upon the marker-based funds, limiting their use to specific uses (gaming but not retail). In addition, a marker might be redeemed (paid back) by the patron by payments from their exchange or via automatic withdrawal by the casino C.

Of course, funds from other sources might be associated with a patron's exchange or funds in the exchange might be transferred to or used in other manners. As described above, a patron's exchange may be utilized as a vehicle for the transfer of funds from one or more remote locations (such as external bank accounts, credit cards or the like) to and/or from the various casino touch points or access points 34 (including gaming machines 24, gaming tables 26, etc.). In one embodiment, these funds comprise legal tender, such as US$.

However, a patron's exchange might be used to facilitate the storage and/or transfer of other elements. For example, a patron might be awarded patron loyalty or tracking points for their wagering or other spending activities at the casino C. The points might be associated with the patron's exchange (or linked thereto), whereby when a patron accesses their exchange, they may view their loyalty points balance and may also use or redeem those points. Such an integration might allow, for example, redemption of points relative to the casino's player loyalty system, such for one or more casino-related rewards, but might also allow for external redemption. For example, the integration might allow for redemption of points, such as through an intermediary, which allows the points to be redeemed for external use, such as for goods/services or rewards of external vendors (e.g. redeem 500 player loyalty points from casino A for a free tank of gas at a Chevron gas station, etc.)

In one embodiment of the invention, the casino financial services system permits the use of crypto-currency(ies). Such crypto-currencies include, but are not limited to Bitcoin, Litecoin, Ethereum, Dogecoin, Uniswap, Tether, etc.

In one embodiment, a patron may be permitted to associate or add funds to their exchange in the form of a digital currency deposit. Such a deposit or transfer might be implemented, for example, via a patron's use of the exchange mobile application (or via a kiosk, etc.) such as by one or more interfaces thereof.

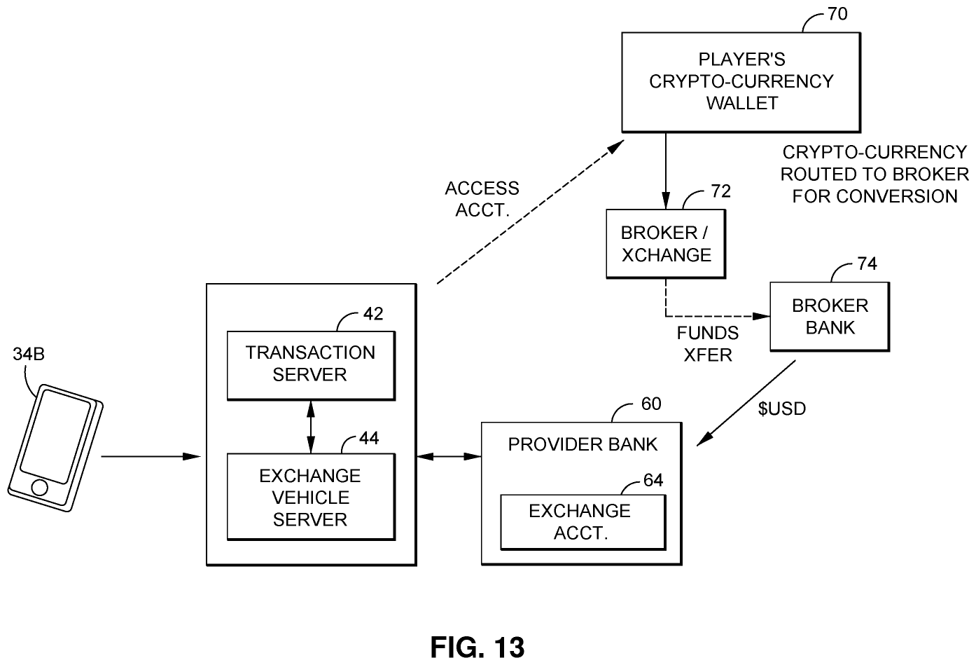

In one embodiment, such as illustrated in FIG. 13, the system may facilitate transfer of crypto-currency from a patron's external crypto currency account or wallet 70 in one or more ways, including but not limited to: a) via a patron's crypto-currency application, such as running on their mobile device; b) via mobile browser; and c) by a QR or other code. For example, in one embodiment, the patron might select the option (from an interface in the exchange mobile application) to access crypto-currency funds via a selected crypto-currency application on their mobile device. The patron may select the crypto-currency application, whereby the exchange mobile application links to the selected crypto-currency application. This linking allows the exchange mobile application to identify the particular crypto-currency account of the patron and make a request to move funds from that account. In another embodiment, the patron might elect the transaction via a mobile browser. The patron may be required to enter their crypto-currency wallet or account address in order to provide access thereto. In yet another example, the patron might elect a QR code transaction, whereupon the exchange mobile application may display a QR code which the patron can scan with their crypto-currency application, thus linking the patron's crypto-currency wallet/account with the exchange account. Of course, other methodology might be utilized to access a patron's crypto-currency, such as by linking a patron's crypto-currency wallet or account, so that the crypto-currency may be accessed.

In a preferred embodiment, when a patron's crypto-currency account is accessed, the patron-designated amount of crypto-currency is accessed (which might comprise, for example, a designated amount of crypto-currency or portions thereof, such as 1 Bitcoin, or an amount of crypto-currency corresponding to a particular amount of legal tender). The designated amount of crypto-currency is then preferable converted to legal tender, such as via a third party broker 74. The value of the legal tender is then transferred to the exchange account 64 (such as by transfer from a broker bank 74 to the financial provider's bank), where it can be used just like other legal tender which is associated with the exchange account 64, via the patron's exchange.

As another aspect of the invention, various deposit and spend processing configurations may be enabled, such as to address scenarios where a request for funds by a patron is denied, such as due to a lack of funds or credit. For example, relative to deposits of funds to a patron's exchange:

(1) The patron might make a request for real-time payment (such as via their mobile device), in response to which the financial provider system 40 sends a request to the patron's bank, and then the patron signs into their bank account, locates the request on the bank end and approves it, thereby authorizing the immediate transfer of funds from their bank account to their exchange (essentially real-time transferring money to themselves).

(2) Pay factoring—a patron might make a request for funds which, when the financial provider system 40 attempts to process the request (such as with the patron's credit card), result in a response in which the transaction is declined (such as due to insufficient funds/credit line). In this case, the system 40 might contact a third party lender who may agree to take the risk of providing the requested funds to the patron and then attempts to recoup the funds by charging the patron's account at a later date. In this example, the patron might or might not be informed of the option to utilize the third party lender, and the third party lender might be provided with information about the request, such as the amount, the amount of credit remaining/funds available from the patron, reason the transaction is declined, etc.

(3) Split flow—a patron might seek funds, such as via a check deposit. The financial provider system 40 might attempt to cash the check to validate the funds for transfer to the patron's exchange. If the transaction fails, such as due to insufficient funds, an option might be implemented to provide the patron with the amount of funds requested based upon delaying the check cashing transaction (such as to a later time when the funds are available in the account).

(4) Aggregation—a patron might seek funds which are obtained from multiple sources and the funds might be aggregated. This principle may be applied to an end point, such as a gaming device where, on demand, funds are pulled from different sources (patron bank account, third party wallet, credit card, etc.) and as a deposit to the patron's exchange (step 1) and then transfer as an aggregated amount to the end point (step 2).

Similarly, relative to a patron's attempt to spend funds, a patron might seek to engage in a spending transaction, such as a $1,000 hotel charge, where the patron's exchange has insufficient funds, such as $800. Various options which are system-defined or patron enabled, might then be implemented to process the transaction. For example, as one option, the financial provider system 40 might access the patron's available funds (e.g. $800 in this example) and then try and process a separate credit card for the remaining $200. As another option, the system 40 might process the entire $1000 charge to the patron's credit card, thus preserving the remaining $800 in their exchange for use in gaming, etc. As yet another example, the system 40 might automatically or optionally allow (directly or via a third party) the redemption of comps, points, or other accounts of value (in some cases, in an order of priority), before moving cash funds from the patron's exchange.

Advantages and Other Aspects of the Invention

As one aspect of the invention, a patron's funds are not held by the casino C or the financial provider FP, but are held in an account at a financial institution. In one preferred embodiment, the patron's funds are held in an account with the funds of other patrons—e.g. a single financial institution account where the funds of each patron are separately tracked, such as via the exchange server 44. In one embodiment, the financial account with which the exchange account funds are associated is an account at the same institution as that where the financial provider FP maintains an operating account, whereby the operating account of the financial provider FP can be used as a reserve account against the exchange account(s) 64 (where such a reserve account would otherwise have to be independently maintained by the financial provider FP if the exchange account 64 were at a separate financial institution).

In this configuration, the financial account(s) that all of the patrons' funds are associated with is managed by the financial provider FP, such as by using the exchange server 44 to maintain a balance of each patron's individual funds at the financial institution, via each patron's exchange.

Aspects of the invention may comprise a multi-channel, multi-jurisdiction, multi-property financial transaction exchange, such as implemented as a digital channel. In various embodiments, the system or exchange acts as a transaction broker, rules engine, credential vault, funds repository, and/or reporting tool.

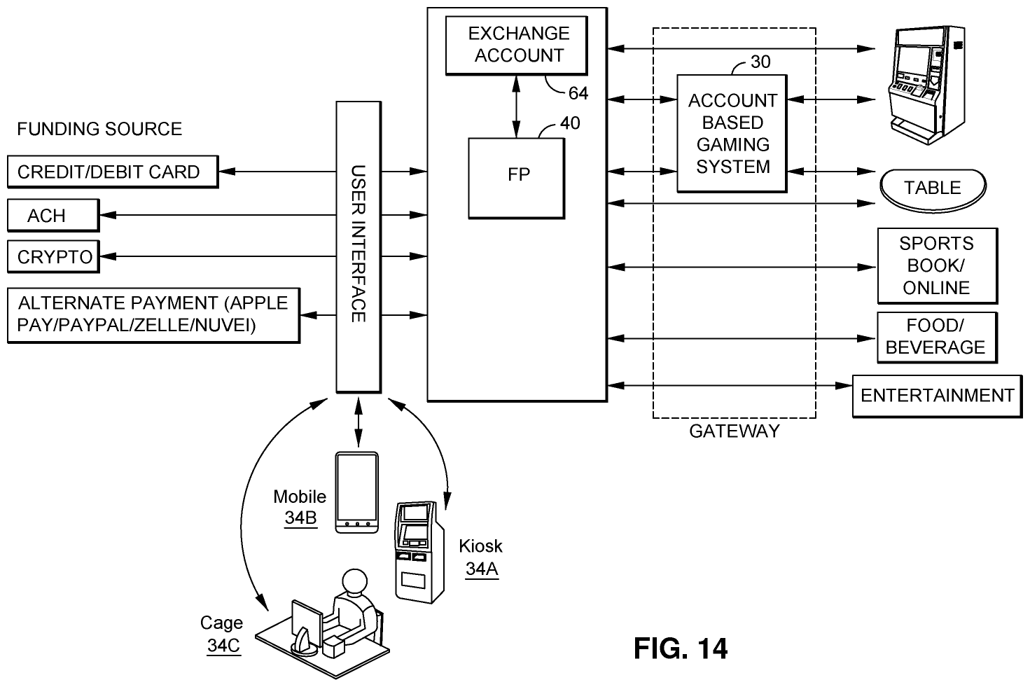

Aspects of the unique nature of the invention will be further appreciated from FIG. 14. FIG. 14 is a schematic overview of functionality which is enabled by the present invention. As illustrated therein and described above, the system permits a patron to move funds from their exchange (as associated with the exchange bank account 64 to a variety of external locations and/or move fund from various sources or locations to their exchange. Those sources might be credit or debit card based (e.g. bank accounts and credit accounts), ACH based (e.g. bank accounts), crypto-based, or be associated with a variety of other sources, systems or platforms, such as, but not limited to Apply Pay®, PayPal®, Zelle®, Nuvei®, various buy now/pay later or other lenders, such as via ACI PayAfter™ by ACI Worldwide of Coral Gables, Fla., or others).

As illustrated, a user may utilize a variety of interfaces or touch-points, such as a kiosk or ATM type device 34A, a mobile communication device 34B, a casino cage 34C or other touch-point to engage the system.

Regardless of the touch-point which is utilized and regardless of the funds source/system, funds are either moved from the external source to the patron's exchange or the funds are moved from the patron's exchange to the one or more external locations.

Further, as illustrated in FIG. 14, the system 20 facilitates the association of funds with a variety of different endpoints, or transfer funds from those endpoints, via a plurality of different gateways G. For example, the system 20 may direct funds to or from a gaming device (such as a gaming table or gaming machine), directly (such as via an interface of the gaming machine, such as a slot accounting system (“SAS”) port or an interface associated with a SAS port. As described above, the system 20 may direct funds to or from a gaming device indirectly, such as through a slot accounting system 30, such as in the manner describe above with reference to FIG. 11).

Further, however, the endpoints might comprise a sports book, online gaming system, a food and/or beverage provider or system, an entertainment service or venue or the like. In such instances the gateways G which is used to facilitate the transfer of funds might comprise a variety of existing or later developed systems or interfaces, such as point of sale (POS) systems (for example, Tacit, by Tacit Innovations, Agilysys Retail by Agilysys NV, LLC of Las Vegas, Nev.) etc. As another example, the patron's exchange might interface with other types of gaming systems, such as the WINAFAR remote gaming system by SoftWeave which allows for remove game play.

It will thus be appreciated that the system 20 of the invention is “multi-channel” in the sense that it can accept funds from and/or transfer funds to different sources, including over different channels, both on the “source” side and on the “endpoint” side. This is a significant different and advantage over other systems for funding gaming, such as only facilitate funding via one path or channel.

An advantage to the method and system is that it can be used in a variety of settings. For example, the system may be implemented relative to a particular casino. In such a configuration, the patron may use their exchange relative to that casino. Graphical user interfaces (such as displayed on the patron's mobile device) may be custom branded for that particular casino, thus creating a customized experience for the patron to that casino and indicating to the patron that the exchange is only relevant to that casino. In other embodiments, the system may be implemented relative to a plurality of different casinos or other gaming properties (such as a plurality of route type locations, such as commonly found when gaming is offered at bars/taverns). In such a configuration, the interfaces may be generically branded. In that case, locations may indicate whether they integrate with the system, whereby the patron may utilize their exchange at a wide range of location or properties that may have different owners.

The servers referenced herein may comprise computing devices, such as which include machine-readable code (e.g. “software”), a memory for storing the machine-readable code, and a processor for executing the code in order to implement functionality. The servers may also comprise one or more communication interfaces, such as for communicating with one or more external devices or systems, such as via one or more networks. In one embodiment, one or more user interfaces may be associated with the server, such as one or more displays (such as video displays), a keyboard, mouse, user station, etc., such as for providing inputs to the server and/or displaying information provided by the server. Such interfaces may be used, for example, to update the functionality of the server, to obtain information from the server, etc. In some embodiments, the server may be configured as a webserver where information may be provided to a web browser of a remote device and where the remote device may provide information to the server.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A multi-channel financial services system for a casino comprising:
a financial services system server comprising a processor, a memory, and a communication interface configured to communicatively couple the server to a plurality of funds sources via a first plurality of digital communication channels, said plurality of funds sources comprising at least one of a bank account, a credit account, a debit account, and a wallet, and configured to communicatively couple the server to a plurality of casino endpoints via a second plurality of digital communication channels, said plurality of casino endpoints comprising at least one of a sports book, a sports book account, a wagering account, a gaming machine, an account based gaming system, a retail purchase system, a gaming table and a food/beverage system;
a transaction database associated with said financial services system server;
machine-readable code stored in said memory of said financial services system server and configured to cause said processor thereof to:
maintain an exchange account for a player in said database, said exchange account comprising at least information regarding a balance of player funds associated with an exchange bank account and funds moved to or from said exchange account;
receive, from said player via a user interface, a transaction request to move an amount of funds between one of said plurality of funds sources and said exchange account or between one of said plurality of casino endpoints and said exchange account;
process said transaction request, comprising:
relative to a transaction request to move funds from one of said plurality of funds sources and said exchange account, transmitting information over one of said first plurality of digital communication channels to effectuate a transfer of said funds from said funds source to said exchange bank account and updating said balance of funds of said player's exchange account;
relative to a transaction request to move funds from said exchange account to one of said plurality of funds sources, transmitting information over one of said first plurality of digital communication channels to effectuate a transfer of said funds from said exchange bank account to said funds source and updating said balance of funds of said player's exchange account;
relative to a transaction request to move funds from said exchange account to one of said casino end points, transmitting information over one of said second plurality of digital communication channels to effectuate a transfer of said funds from said player's exchange account to said casino end point, updating said balance of funds of said player's exchange account, and transferring said funds from said balance of player funds associated with said exchange bank account to a bank account of said casino; and
relative to a transaction request to move funds from one of said casino end points and said exchange account, transmitting information over one of said second plurality of digital communication channels to effectuate a transfer of said funds from said casino end point to said, updating said balance of funds of said player's exchange account, and increasing said balance of player funds associated with said exchange bank account based upon a transfer of funds from a bank account of said casino.

2. The system of claim 1, wherein said user interface comprises at least one of: a kiosk, a cashier station, a point of sale device, a gaming device, and a mobile device of the player.

3. The system of claim 1, further comprising a first set of rules corresponding to a first jurisdiction and a second set of rules corresponding to a second jurisdiction, wherein said server is configured to process said transaction request based upon said first set of rules or said second set of rules based upon a location of said request.

4. The system of claim 3, wherein said first set of rules and said second set of rules comprise rules regarding at least one of: transaction velocity limits, transaction limits by type of transaction, gaming limits and casino controls.

5. The system of claim 3, wherein said processor is configured to receive information regarding said location from said user interface.

6. The system of claim 1, wherein said server communicates with the second plurality of digital communication channels of a first casino and a second casino, said first casino located in said first jurisdiction and said second casino located in said second jurisdiction.

7. The system of claim 1, wherein said processor is configured to receive information from said player regarding a user control comprising at least one of: one or more transaction alerts, one or more transaction limits, and one or more transaction preferences, and wherein said processor is configured to store said user control in association with said player's exchange account and process said transaction request in accordance with said user control.

8. The system of claim 1, wherein said financial system services server comprises a transaction server configured to receive said transaction request and which communicates with said first and second plurality of digital communication channels, and an exchange server which communicates with said transaction server and an external banking network to maintain information regarding said player's exchange account.

9. The system of claim 1, wherein said transmitting information over one of said second plurality of digital communication channels to effectuate a transfer of said funds from said player's exchange account to said casino end point results in an increase in a credit balance associated with a gaming machine.

10. The system of claim 1, further comprising machine-readable code stored in said memory of said financial services system server and configured to cause said processor thereof to receive a request for a new retail credit account from said player and to communicate with an external retailer to create a new credit account for said player and to associate said credit account with said player's exchange account.

11. The system of claim 1, wherein said funding source comprises cryptocurrency associated with a wallet.

12. A method of providing financial transaction services between a player and a casino comprising:
communicatively coupling a financial system of a licensed money transmitter with a plurality of casino end points, said licensed money transmitter financial system comprising at least one financial services system server comprising a processor, a memory, and a communication interface and a transaction database associated with said financial services system server;
communicatively coupling said licensed money transmitter financial system with at least one external banking network;
establishing, by said licensed money transmitter, at least one exchange bank account with a bank associated with said at least one external banking network;
maintaining, in said database, an exchange account for said player, said exchange account comprising at least information regarding a balance of player funds associated with said at least one exchange bank account and funds moved to or from said exchange account;
receiving, from said player via a user interface, a transaction request to move an amount of funds associated with said player's exchange account and one of said plurality of casino endpoints;
transmitting, from said licensed money transmitter financial system to said casino endpoint, information regarding said funds to associate said funds with said casino endpoint and correspondingly reducing said balance of funds of said player's exchange account; and
transferring, via said at least one external banking network, said amount of funds from said at least one exchange bank account to a bank account of said casino.

13. The method of claim 12, wherein said casino endpoint comprises a gaming machine.

14. The method of claim 13, comprising transmitting said information regarding said funds from said licensed money transmitter financial system over an casino account based wagering system to said gaming machine or an interface in communication with an accounting interface of said gaming machine.

15. The method of claim 13, wherein said at least one exchange bank account is associated with an operating account of said money transmitter.

16. The method of claim 13, wherein said information regarding said funds is transmitted from said licensed money transmitter financial system over a digital communication channel of at least one casino system.

17. The method of claim 13, wherein said exchange bank account comprises an single bank account of funds belonging to multiple players.

18. The method of claim 13, wherein said balance of funds comprises a ledger.

19. The method of claim 13, further comprising processing said transaction request in accordance with one or more location-based rule sets based upon a location of said transaction request.

20. The method of claim 13, wherein said user interface comprises at least one of: a kiosk, a cashier station, a point of sale device, a gaming device, and a mobile device of the player.
